(19) United States
(12) Patent Application Publication
(10) Pub. No.: US 2022/0242446 A1
(43) Pub. Date: Aug. 4, 2022

(54) AUTOMATIC DRIVING CONTROL DEVICE AND AUTOMATIC DRIVING CONTROL METHOD

(71) Applicant: Mitsubishi Electric Corporation, Tokyo (JP)

(72) Inventor: Takumi SATO, Tokyo (JP)

(73) Assignee: Mitsubishi Electric Corporation, Tokyo (JP)

(21) Appl. No.: 17/629,678

(22) PCT Filed: Sep. 2, 2019
(86) PCT No.: PCT/JP2019/034441

§ 371 Date: Jan. 24, 2022

(51) Int. Cl. B60W 60/00; G06V 20/58; B60W 50/14

(52) U.S. Cl. CPC B60W 60/005; G06V 20/58; B60W 50/14; B60W 2555/20; B60W 2420/52; B60W 2554/802; B60W 2420/42

(57) ABSTRACT

Included are: an information acquisition unit for acquiring a plurality of pieces of vehicle surrounds information output from a plurality of respective sensors; a control amount inferring unit for inferring an automatic driving control amount on the basis of the plurality of pieces of vehicle surrounds information and a machine learning model, and outputting the automatic driving control amount; a monitoring unit for determining whether or not the reliability of any one of the plurality of pieces of vehicle surrounds information has decreased; and a control unit for controlling, when the monitoring unit determines that the reliability of any one of the plurality of pieces of vehicle surrounds information has decreased, the control amount inferring unit in such a way as to output the automatic driving control amount excluding an influence of the one of the plurality of pieces of vehicle surrounds information whose reliability is determined to be decreased.

### TECHNICAL FIELD

The present invention relates to an automatic driving control device and an automatic driving control method for performing automatic driving control of a vehicle.

### BACKGROUND ART

Information regarding an area around a vehicle (hereinafter, referred to as “vehicle surrounds information”) can be obtained from a plurality of sensors. Conventionally, there is a technique of inferring and outputting various control amounts necessary for automatic driving control of a vehicle (hereinafter, referred to as “automatic driving control amount”) by inputting a plurality of pieces of vehicle surrounds information output from such a plurality of respective sensors, to a machine-learned model (hereinafter, referred to as a “machine learning model”).

Here, Patent Literature 1 discloses a control device using a map of a surrounding environment generated on the basis of a plurality of images captured by a compound-eye camera in order to recognize the surrounding environment during execution of automatic driving control of a vehicle. For example, when malfunction occurs in one of two in-vehicle cameras constituting the compound-eye camera, the control device estimates the surrounding environment on the basis of an image captured by one in-vehicle camera that normally operates.

### CITATION LIST

### Patent Literatures

Patent Literature 1: JP 2019-34664 A

### SUMMARY OF INVENTION

### Technical Problem

The above technique of inferring an automatic driving control amount using a machine learning model has a problem. The problem is that when the reliability of information acquired from any one of the plurality of sensors has decreased, the automatic driving control amount may be unsuitable for automatic driving control of a vehicle.

The control device disclosed in Patent Literature 1 estimates the surrounding environment on the basis of an image captured by an in-vehicle camera that normally operates when malfunction occurs in one of the in-vehicle cameras. Specifically, the estimation is performed using a theoretically determined calculation formula. Meanwhile, since the machine learning model does not perform inference using a theoretically determined calculation formula, the technique in the control device disclosed in Patent Literature 1 cannot be used as a solution to the above problem.

The present invention has been made in order to solve the above problem, and an object of the present invention is to provide an automatic driving control device which infers and outputs an automatic driving control amount on the basis of a machine learning model and a plurality of pieces of vehicle surrounds information output from a plurality of respective sensors, and which is capable of outputting an automatic driving control amount suitable for automatic driving control of a vehicle even when the reliability of any one of the plurality of pieces of vehicle surrounds information has decreased.

### Solution to Problem

An automatic driving control device according to the present invention includes: an information acquisition unit for acquiring a plurality of pieces of vehicle surrounds information output from a plurality of respective sensors; a control amount inferring unit for inferring an automatic driving control amount on the basis of the plurality of pieces of vehicle surrounds information acquired by the information acquisition unit and at least one machine learning model, and outputting the automatic driving control amount; a monitoring unit for determining whether or not the reliability of any one of the plurality of pieces of vehicle surrounds information acquired by the information acquisition unit has decreased; and a control unit for controlling, when the monitoring unit determines that the reliability of any one of the plurality of pieces of vehicle surrounds information has decreased, the control amount inferring unit in such a way as to output the automatic driving control amount excluding an influence of the one of the plurality of pieces of vehicle surrounds information whose reliability is determined to be decreased.

### Advantageous Effects of Invention

According to the present invention, it is possible to output an automatic driving control amount suitable for automatic driving control of a vehicle even when the reliability of any one of the plurality of pieces of vehicle surrounds information output from the plurality of respective sensors, has decreased.

### BRIEF DESCRIPTION OF DRAWINGS

FIG. 1 is a diagram illustrating a configuration example of a vehicle on which an automatic driving control device according to a first embodiment is mounted.

FIG. 2 is a diagram illustrating a configuration example of the automatic driving control device according to the first embodiment.

FIG. 3 is a flowchart for explaining an operation of the automatic driving control device according to the first embodiment.

FIG. 4 is a diagram illustrating a configuration example of an automatic driving control device according to a second embodiment.

FIG. 5 is a flowchart for explaining an operation of the automatic driving control device according to the second embodiment.

FIG. 6 is a diagram illustrating a configuration example of an automatic driving control device according to a third embodiment.

FIG. 7 show diagrams for explaining examples of captured images having different pixel luminance values in the third embodiment, in which FIG. 7A is an example of a captured image when all pixels of a captured image have luminance at which objects in the captured image can be sufficiently identified, FIG. 7B is an example of a captured image when all pixels of a captured image have luminance which causes such a dark image that objects in the captured image cannot be recognized, and FIG. 7C is an example of a captured image when all pixels of a captured image have luminance which causes such a bright image that objects in the captured image cannot be recognized.

FIG. 8 is a flowchart for explaining an operation of the automatic driving control device according to the third embodiment.

FIG. 9 is a diagram illustrating a configuration example of an automatic driving control device according to a fourth embodiment.

FIG. 10 is a flowchart for explaining an operation of the automatic driving control device according to the fourth embodiment.

FIG. 11 is a diagram illustrating a configuration example of an automatic driving control device according to a fifth embodiment.

FIG. 12 is a diagram illustrating an example of a screen of a display that is caused to display notification information by a notification control unit in the fifth embodiment.

FIG. 13 is a diagram illustrating another example of the screen of the display that is caused to display notification information by the notification control unit in the fifth embodiment.

FIG. 14 is a diagram illustrating a configuration example of an automatic driving control device according to a sixth embodiment.

FIG. 15 is a flowchart for explaining an operation of the automatic driving control device according to the sixth embodiment.

FIGS. 16A and 16B are diagrams illustrating examples of a hardware configuration of the automatic driving control devices according to the first to sixth embodiments.

FIG. 17 is a diagram illustrating a configuration example of an automatic driving control system in which the automatic driving control device according to the first embodiment described with reference to FIG. 2 is included in a server.

### DESCRIPTION OF EMBODIMENTS

Hereinafter, embodiments of the present invention will be described in detail with reference to the drawings.

### First Embodiment

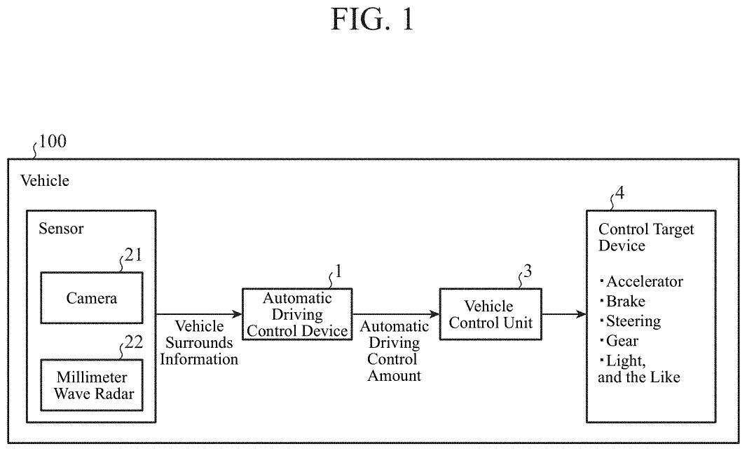

FIG. 1 is a diagram illustrating a configuration example of a vehicle 100 on which an automatic driving control device 1 according to a first embodiment is mounted.

The automatic driving control device 1 according to the first embodiment is a device mounted on the vehicle 100 that can automatically travel without a driving operation performed by a person. As illustrated in FIG. 1, in addition to the automatic driving control device 1, a sensor, a vehicle control unit 3, and a control target device 4 are mounted on the vehicle 100.

On the vehicle 100, a plurality of sensors for outputting information regarding an area around the vehicle 100 is mounted. The information output from each of the plurality of sensors is information regarding other vehicles present around the vehicle 100, information regarding obstacles other than the vehicles present around the vehicle 100, information regarding a state of a traffic signal, information regarding a lane, information regarding terrain, information regarding a road sign, or the like. Examples of the information regarding a lane include a white line and a road marking.

In the first embodiment, the sensors include a camera 21 and a millimeter wave radar 22.

The camera 21 captures an image of an area around the vehicle 100, such as an image of an area in front of the vehicle 100. The camera 21 outputs the captured image of an area around the vehicle 100 to the automatic driving control device 1.

The millimeter wave radar 22 measures a distance from the vehicle 100 to an object present around the vehicle 100. The millimeter wave radar 22 outputs information regarding the measured distance from the vehicle 100 to the object (hereinafter, referred to as “distance information”) to the automatic driving control device 1. The automatic driving control device 1 infers an automatic driving control amount necessary for automatic driving control of the vehicle 100 on the basis of at least a captured image output from the camera 21 and distance information output from the millimeter wave radar 22.

In the first embodiment, information output from the sensor and used for inference of an automatic driving control amount in the automatic driving control device 1, such as the captured image or distance information described above, is also collectively referred to as “vehicle surrounds information”. The vehicle surrounds information is information used for inference of an automatic driving control amount in the automatic driving control device 1, and can include various pieces of information regarding an area around the vehicle 100.

The first embodiment is on the premise that, for example, one or more sensors among the plurality of sensors have a negligibly low possibility of breakdown, and thus substantially no problem occurs in vehicle surrounds information output from the one or more sensors. Meanwhile, the first embodiment is on the premise that, among the plurality of sensors, for example, one or more other sensors have a higher possibility of breakdown than the above some sensors, and thus a problem relatively easily occurs in vehicle surrounds information output from the one or more sensors. Specifically, the first embodiment is on the premise that, out of the camera 21 and the millimeter wave radar 22 included in the sensor according to the first embodiment, for example, the camera 21 has a negligibly low possibility of breakdown, and thus substantially no problem occurs in a captured image taken by the camera 21. Meanwhile, the first embodiment is on the premise that, for example, the millimeter wave radar 22 has a higher possibility of breakdown than the camera 21, and thus a problem relatively easily occurs in distance information output from the millimeter wave radar 22.

In the first embodiment, vehicle surrounds information is used as input data for a machine learning model for inferring an automatic driving control amount as described later. In the first embodiment, a degree indicating whether vehicle surrounds information is reliable as input data for inferring an automatic driving control amount suitable for automatic driving control of the vehicle 100, is referred to as “reliability” of the vehicle surrounds information.

The automatic driving control device 1 infers the automatic driving control amount on the basis of vehicle surrounds information output from the sensors. Details of the inference of the automatic driving control amount by the automatic driving control device 1 will be described later together with a configuration example of the automatic driving control device 1.

The automatic driving control device 1 outputs the inferred automatic driving control amount to the vehicle control unit 3 mounted on the vehicle 100.

The vehicle control unit 3 controls the vehicle 100 on the basis of the automatic driving control amount output from the automatic driving control device 1. Specifically, the vehicle control unit 3 controls the control target device 4, and thereby causes the vehicle 100 to automatically travel. The control target device 4 is a device that is mounted on the vehicle 100 and operates in order to cause the vehicle 100 to automatically travel on the basis of control by the vehicle control unit 3. The control target device 4 is, for example, an accelerator, a brake, a steering, a gear, or a light.

The automatic driving control amount output from the automatic driving control device 1 may be a specific control amount of each control target device 4 such as a brake, an accelerator, or a steering operation, or may be information indicating a traveling trajectory including a plurality of time-series latitude and longitude values. When the automatic driving control amount is the information indicating a traveling trajectory, the vehicle control unit 3 calculates a specific control amount of each control target device 4 in such a manner that the vehicle 100 automatically travels according to the traveling trajectory, and controls each control target device 4 on the basis of the calculated control amount.

Details of the automatic driving control device 1 according to the first embodiment will be described.

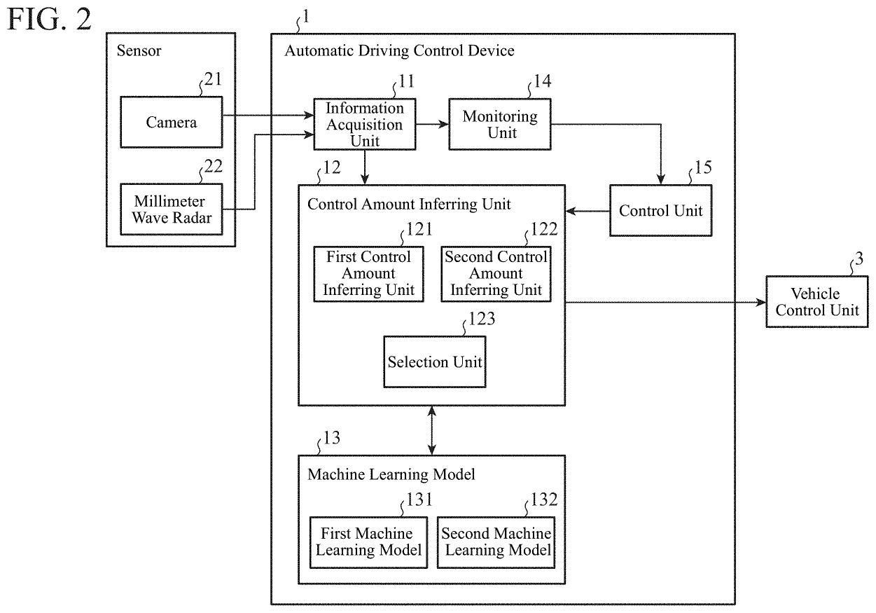

FIG. 2 is a diagram illustrating a configuration example of the automatic driving control device 1 according to the first embodiment.

The automatic driving control device 1 includes an information acquisition unit 11, a control amount inferring unit 12, a machine learning model 13, a monitoring unit 14, and a control unit 15. The control amount inferring unit 12 includes a first control amount inferring unit 121, a second control amount inferring unit 122, and a selection unit 123. The machine learning model 13 includes a first machine learning model 131 and a second machine learning model 132.

The information acquisition unit 11 acquires a plurality of pieces of vehicle surrounds information output from the plurality of respective sensors. Specifically, the information acquisition unit 11 acquires a captured image captured by the camera 21 and distance information measured by the millimeter wave radar 22 as vehicle surrounds information. The information acquisition unit 11 outputs the acquired vehicle surrounds information to the control amount inferring unit 12 and the monitoring unit 14.

The control amount inferring unit 12 infers an automatic driving control amount of the vehicle 100 on the basis of the plurality of pieces of vehicle surrounds information acquired by the information acquisition unit 11 and the machine learning model 13, and outputs the automatic driving control amount. In the first embodiment, specifically, the control amount inferring unit 12 outputs the inferred automatic driving control amount to the vehicle control unit 3 in association with information for specifying the control target device 4 to be controlled.

The first control amount inferring unit 121 of the control amount inferring unit 12 infers a first automatic driving control amount on the basis of all of the plurality of pieces of vehicle surrounds information acquired by the information acquisition unit 11 and the first machine learning model 131. Specifically, the first control amount inferring unit 121 infers the first automatic driving control amount on the basis of a captured image acquired by the information acquisition unit 11 from the camera 21, distance information acquired by the information acquisition unit 11 from the millimeter wave radar 22, and the first machine learning model 131. The first machine learning model 131 will be described later.

The first control amount inferring unit 121 outputs the inferred first automatic driving control amount to the selection unit 123.

The second control amount inferring unit 122 of the control amount inferring unit 12 infers a second automatic driving control amount on the basis of a part of the plurality of pieces of vehicle surrounds information acquired by the information acquisition unit 11 and the second machine learning model 132. Specifically, the second control amount inferring unit 122 infers the second automatic driving control amount on the basis of a piece of vehicle surrounds information other than a piece of vehicle surrounds information whose reliability may decrease among the plurality of pieces of vehicle surrounds information and the second machine learning model 132.

As described above, the first embodiment is on the premise that substantially no problem occurs in a captured image taken by the camera 21, while a problem relatively easily occurs in distance information made by the millimeter wave radar 22. Therefore specifically, as described later, the second machine learning model 132 according to the first embodiment infers the second automatic driving control amount by receiving only a captured image acquired by the information acquisition unit 11 as input.

The second control amount inferring unit 122 outputs the inferred second automatic driving control amount to the selection unit 123.

The selection unit 123 selects, from the first automatic driving control amount and the second automatic driving control amount, which to output. In the first embodiment, specifically, the selection unit 123 outputs the selected automatic driving control amount to the vehicle control unit 3.

As described later, when the monitoring unit 14 determines that none of the reliabilities of the plurality of pieces of vehicle surrounds information have decreased, the control unit 15 controls the control amount inferring unit 12 in such a way as to output the first automatic driving control amount. When the control amount inferring unit 12 is controlled by the control unit 15 in such a way as to output the first automatic driving control amount, the selection unit 123 selects and outputs the first automatic driving control amount.

In addition, when the monitoring unit 14 determines that the reliability of a piece of vehicle surrounds information other than a part of the plurality of pieces of vehicle surrounds information, the part being input to the second machine learning model 132, among the plurality of pieces of vehicle surrounds information has decreased, the control unit 15 controls the control amount inferring unit 12 in such a way as to output the second automatic driving control amount. When the control amount inferring unit 12 is controlled by the control unit 15 in such a way as to output the second automatic driving control amount, the selection unit 123 selects and outputs the second automatic driving control amount.

The machine learning model 13 is a learned model in machine learning. Specifically, the machine learning model 13 is a model subjected to machine learning in advance in such a way as to output an automatic driving control amount necessary for automatic driving control of the vehicle 100 when a plurality of pieces of vehicle surrounds information acquired by the information acquisition unit 11 is input to the machine learning model 13. The machine learning model 13 includes, for example, a neural network.

In the first embodiment, the machine learning model 13 includes the first machine learning model 131 and the second machine learning model 132.

The first machine learning model 131 receives all of the plurality of pieces of vehicle surrounds information acquired by the information acquisition unit 11 as input, and outputs the first automatic driving control amount. In the first embodiment, the first machine learning model 131 receives both a captured image acquired by the information acquisition unit 11 from the camera 21 and distance information acquired by the information acquisition unit 11 from the millimeter wave radar 22 as input, and outputs the first automatic driving control amount.

The second machine learning model 132 receives a part of the plurality of pieces of vehicle surrounds information acquired by the information acquisition unit 11 as input, and outputs the second automatic driving control amount. Specifically, the second machine learning model 132 outputs the second automatic driving control amount when the second machine learning model 132 receives a piece of vehicle surrounds information other than a piece of vehicle surrounds information whose reliability has decreased among the plurality of pieces of vehicle surrounds information acquired by the information acquisition unit 11 as input.

As described above, the first embodiment is on the premise that substantially no problem occurs in a captured image taken by the camera 21, while a problem relatively easily occurs in distance information made by the millimeter wave radar 22. Therefore, specifically, the second machine learning model 132 in the first embodiment outputs the second automatic driving control amount by receiving only a captured image acquired by the information acquisition unit 11 as input.

In the first embodiment, as illustrated in FIG. 2, the machine learning model 13 is included in the automatic driving control device 1, but this is merely an example. The machine learning model 13 may be included in a place that can be referred to by the automatic driving control device 1, and that is outside the automatic driving control device 1.

The monitoring unit 14 determines whether or not the reliability of any one of the plurality of pieces of vehicle surrounds information acquired by the information acquisition unit 11 has decreased. The first embodiment is on the premise that substantially no problem occurs in a captured image taken by the camera 21, while a problem relatively easily occurs in distance information made by the millimeter wave radar 22. Therefore, the monitoring unit 14 in the first embodiment determines whether or not the reliability of distance information acquired by the information acquisition unit 11 from the millimeter wave radar 22 has decreased.

Specifically, the monitoring unit 14 acquires, on the basis of a captured image acquired from the camera 21, a distance from the vehicle 100 to a certain object present on the captured image in real space (hereinafter, referred to as “reference distance”). In addition, the monitoring unit 14 calculates a difference between the reference distance and a distance from the vehicle 100 to the object based on distance information acquired from the millimeter wave radar 22. Then, the monitoring unit 14 determines whether or not the calculated difference is equal to or smaller than a preset threshold (hereinafter, referred to as “radar determination threshold”). When determining that the calculated difference is equal to or smaller than the radar determination threshold, the monitoring unit 14 determines that the reliability of the distance information has not decreased. Meanwhile, when determining that the calculated difference is larger than the radar determination threshold, the monitoring unit 14 determines that the reliability of the distance information has decreased. Note that, as a method for the monitoring unit 14 to acquire the reference distance on the basis of a captured image acquired from the camera 21, any known method can be adopted. Examples of a specific method include a method using a learned model based on learning in which a set of a captured image in which an object is captured and an actual measurement value of a distance from the vehicle 100 to the object in real space is used as training data.

The monitoring unit 14 outputs information regarding a result of determining whether or not the reliability of any one of the plurality of pieces of vehicle surrounds information acquired by the information acquisition unit 11 has decreased (hereinafter, referred to as “monitoring result information”) to the control unit 15. For example, when determining that the reliability of any one of the plurality of pieces of vehicle surrounds information has decreased, the monitoring unit 14 outputs monitoring result information indicating that the reliability of the vehicle surrounds information has decreased to the control unit 15. The monitoring result information includes information for specifying which piece of vehicle surrounds information has the decreased reliability. In the first embodiment, when determining that the reliability of distance information acquired from the millimeter wave radar 22 has decreased, the monitoring unit 14 outputs monitoring result information indicating that the reliability of the distance information has decreased to the control unit 15.

In addition, for example, when determining that none of the reliabilities of the plurality of pieces of vehicle surrounds information have decreased, the monitoring unit 14 outputs monitoring result information indicating that the reliability of the vehicle surrounds information has not decreased to the control unit 15.

When the monitoring unit 14 determines that the reliability of any one of the plurality of pieces of vehicle surrounds information has decreased, the control unit 15 controls the control amount inferring unit 12 in such a way as to output an automatic driving control amount excluding an influence of the piece of vehicle surrounds information whose reliability is determined to be decreased.

Specifically, when the monitoring unit 14 determines that the reliability of a piece of vehicle surrounds information other than a part of the plurality of pieces of vehicle surrounds information, the part being input to the second machine learning model 132, among the plurality of pieces of vehicle surrounds information has decreased, the control unit 15 controls the control amount inferring unit 12 in such a way as to output the second automatic driving control amount. When the control amount inferring unit 12 is controlled by the control unit 15 in such a way as to output the second automatic driving control amount, the selection unit 123 of the control amount inferring unit 12 selects and outputs the second automatic driving control amount.

Meanwhile, when the monitoring unit 14 determines that none of the reliabilities of the plurality of pieces of vehicle surrounds information have decreased, the control unit 15 controls the control amount inferring unit 12 in such a way as to output the first automatic driving control amount. When the control amount inferring unit 12 is controlled by the control unit 15 in such a way as to output the first automatic driving control amount, the selection unit 123 of the control amount inferring unit 12 selects and outputs the first automatic driving control amount.

An operation of the automatic driving control device 1 according to the first embodiment will be described.

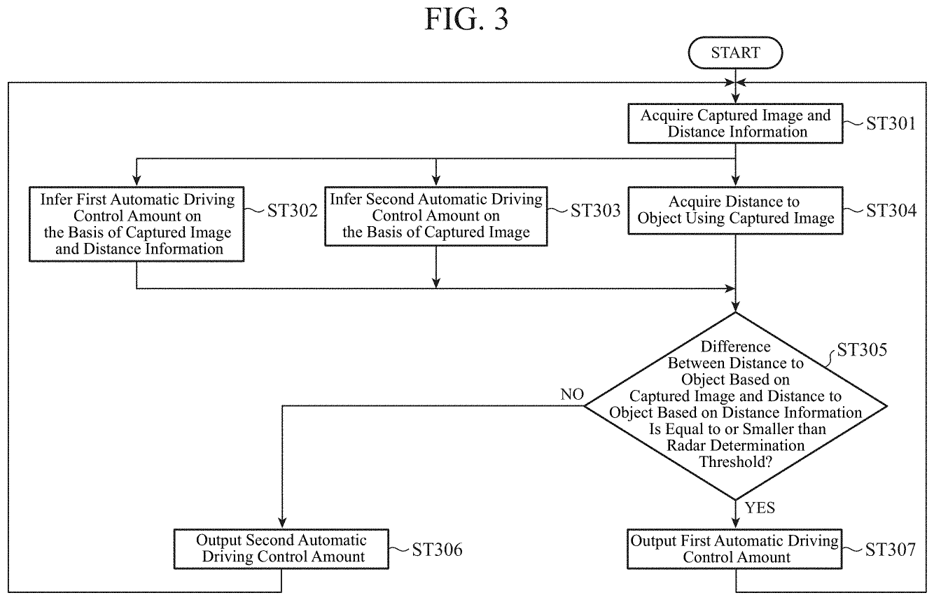

FIG. 3 is a flowchart for explaining the operation of the automatic driving control device 1 according to the first embodiment.

The information acquisition unit 11 acquires a plurality of pieces of vehicle surrounds information output from the plurality of respective sensors. Specifically, the information acquisition unit 11 acquires a captured image captured by the camera 21 and distance information measured by the millimeter wave radar 22 (step ST301). The information acquisition unit 11 outputs the acquired vehicle surrounds information to the control amount inferring unit 12 and the monitoring unit 14.

The first control amount inferring unit 121 of the control amount inferring unit 12 infers the first automatic driving control amount on the basis of all of the plurality of pieces of vehicle surrounds information acquired by the information acquisition unit 11 in step ST301 and the first machine learning model 131. Specifically, the first control amount inferring unit 121 infers the first automatic driving control amount on the basis of the captured image acquired by the information acquisition unit 11 from the camera 21 in step ST301, the distance information acquired by the information acquisition unit 11 from the millimeter wave radar 22 in step ST301, and the first machine learning model 131 (step ST302).

The first control amount inferring unit 121 outputs the inferred first automatic driving control amount to the selection unit 123.

The second control amount inferring unit 122 of the control amount inferring unit 12 infers the second automatic driving control amount on the basis of a part of the plurality of pieces of vehicle surrounds information acquired by the information acquisition unit 11 in step ST301 and the second machine learning model 132. Specifically, the second control amount inferring unit 122 infers the second automatic driving control amount by receiving only the captured image acquired by the information acquisition unit 11 from the camera 21 in step ST301 as input (step ST303).

The second control amount inferring unit 122 outputs the inferred second automatic driving control amount to the selection unit 123.

The monitoring unit 14 determines whether or not the reliability of any one of the plurality of pieces of vehicle surrounds information acquired by the information acquisition unit 11 has decreased. Specifically, first, the monitoring unit 14 acquires, on the basis of the captured image acquired by the information acquisition unit 11 from the camera 21 in step ST301, a reference distance for a certain object present on the captured image (step ST304).

Then, the monitoring unit 14 calculates a difference between the reference distance acquired in step ST304 and a distance from the vehicle 100 to the object based on the distance information acquired by the information acquisition unit 11 from the millimeter wave radar 22 in step ST301, and determines whether or not the calculated difference is equal to or smaller than the radar determination threshold (step ST305).

If it is determined in step ST305 that the calculated difference is larger than the radar determination threshold (“NO” in step ST305), the monitoring unit 14 determines that the reliability of the distance information acquired from the millimeter wave radar 22 has decreased, and outputs monitoring result information indicating that the reliability of the distance information has decreased to the control unit 15.

The control unit 15 controls the control amount inferring unit 12 in such a way as to output the second automatic driving control amount inferred by the second control amount inferring unit 122 in step ST303. The selection unit 123 selects the second automatic driving control amount and outputs the second automatic driving control amount to the vehicle control unit 3 (step ST306).

If it is determined in step ST305 that the calculated difference is equal to or smaller than the radar determination threshold (“YES” in step ST305), the monitoring unit 14 determines that the reliability of the distance information acquired from the millimeter wave radar 22 has not decreased, and outputs monitoring result information indicating that the reliability of the distance information has not decreased to the control unit 15.

The control unit 15 controls the control amount inferring unit 12 in such a way as to output the first automatic driving control amount inferred by the first control amount inferring unit 121 in step ST302. The selection unit 123 selects the first automatic driving control amount and outputs the first automatic driving control amount to the vehicle control unit 3 (step ST307).

After the operation in step ST306 or step ST307 is performed, the operation of the automatic driving control device 1 returns to step ST301, and the subsequent operations are repeated.

In the operations described above, when inferring the first automatic driving control amount in step ST302, the first control amount inferring unit 121 does not necessarily use the captured image and the distance information acquired by the information acquisition unit 11 in the immediately preceding step ST301. For example, the information acquisition unit 11 may cause a storage unit (not illustrated) to store the acquired vehicle surrounds information, and the first control amount inferring unit 121 may infer the first automatic driving control amount using the captured image and the distance information stored in the storage unit and acquired by the information acquisition unit 11 before the immediately preceding step ST301.

In addition, when inferring the second automatic driving control amount in step ST303, the second control amount inferring unit 122 does not necessarily use the captured image acquired by the information acquisition unit 11 in the immediately preceding step ST301. For example, the second control amount inferring unit 122 may infer the second automatic driving control amount using the captured image stored in the storage unit and acquired by the information acquisition unit 11 before the immediately preceding step ST301.

As described above, the automatic driving control device 1 according to the first embodiment determines whether or not the reliability of the distance information output from the millimeter wave radar 22 has decreased, and when determining that the reliability of the distance information has decreased, the automatic driving control device 1 can continuously infer the automatic driving control amount without using the distance information output from the millimeter wave radar 22.

Note that, even when determining that the reliability of the distance information acquired from the millimeter wave radar 22 has decreased, the automatic driving control device 1 can continue automatic driving of the vehicle 100, but the level of the automatic driving may decrease. That is, since the second control amount inferring unit 122 has a smaller number of pieces of vehicle surrounds information used for inference of the automatic driving control amount than the first control amount inferring unit 121, there may be a difference in the level of inference.

Specifically, for example, there may be such a difference in the level of inference that the first control amount inferring unit 121 can infer an automatic driving control amount for performing complicated control such as a lane change during congestion, whereas the second control amount inferring unit 122 can only infer an automatic driving control amount for performing traveling to keep a traveling lane.

However, in a case where it is not considered that the reliability of the distance information output from the millimeter wave radar 22 may decrease, specifically, in a case where the automatic driving control device 1 includes only the first control amount inferring unit 121, when the reliability of the distance information decreases, there is a high possibility that the automatic driving cannot be normally continued. Meanwhile, the automatic driving control device 1 according to the first embodiment includes the second control amount inferring unit 122, and the second control amount inferring unit 122 can infer the second automatic driving control amount on the basis of the captured image acquired from the camera 21 and the second machine learning model 132. Then, when the reliability of the distance information output from the millimeter wave radar 22 has decreased, the automatic driving of the vehicle 100 is controlled using the second automatic driving control amount inferred by the second control amount inferring unit 122. As a result, even when the reliability of any one of the plurality of pieces of vehicle surrounds information acquired from the plurality of sensors has decreased, the automatic driving of the vehicle 100 can be continued at a relatively low level.

In the above-described first embodiment, in the automatic driving control device 1, before the monitoring unit 14 determines whether or not the reliability of the distance information has decreased (see step ST305 in FIG. 3), the first control amount inferring unit 121 and the second control amount inferring unit 122 infer the first automatic driving control amount and the second automatic driving control amount, respectively (see steps ST302 and ST303 in FIG. 3). However, this is merely an example, and the first control amount inferring unit 121 or the second control amount inferring unit 122 may infer the automatic driving control amount in response to determination by the monitoring unit 14 as to whether or not the reliability of the distance information has decreased. Specifically, for example, when the monitoring unit 14 determines that the reliability of the distance information has decreased, the control unit 15 controls the control amount inferring unit 12 in such a way as to output the second automatic driving control amount. When the control amount inferring unit 12 is controlled by the control unit 15 in such a way as to output the second automatic driving control amount, the second control amount inferring unit 122 infers the second automatic driving control amount. Meanwhile, when the monitoring unit 14 determines that the reliability of the distance information has not decreased, the control unit 15 controls the control amount inferring unit 12 in such a way as to output the first automatic driving control amount. When the control amount inferring unit 12 is controlled by the control unit 15 in such a way as to output the first automatic driving control amount, the first control amount inferring unit 121 infers the first automatic driving control amount. The control amount inferring unit 12 outputs the first automatic driving control amount inferred by the first control amount inferring unit 121 or the second automatic driving control amount inferred by the second control amount inferring unit 122 to the vehicle control unit 3 on the basis of the control of the control unit 15. In such a configuration, the automatic driving control device 1 can exclude the selection unit 123.

In addition, the above-described first embodiment is on the premise that the two pieces of information, namely, the captured image and the distance information are used as the plurality of pieces of vehicle surrounds information, and a problem relatively easily occurs only in the distance information. Thus, only the second machine learning model 132 receiving the captured image as input is included as a machine learning model used when the reliability of any one of the plurality of pieces of vehicle surrounds information has decreased. However, among the plurality of pieces of vehicle surrounds information, there may be a plurality of pieces of vehicle surrounds information for which a possibility of a decrease in reliability should be considered. In this case, included are second machine learning models each of which infers by receiving, as input, pieces of vehicle surrounds information excluding a corresponding one of the plurality of pieces of vehicle surrounds information for which a possibility of a decrease in reliability should be considered, and second machine learning models each of which infers by receiving, as input, pieces of vehicle surrounds information excluding a corresponding combination of two or more of the plurality of pieces of vehicle surrounds information for which a possibility of a decrease in reliability should be considered.

As described above, according to the first embodiment, the automatic driving control device 1 includes: the information acquisition unit 11 for acquiring a plurality of pieces of vehicle surrounds information output from the plurality of respective sensors (the camera 21 and the millimeter wave radar 22); the control amount inferring unit 12 for inferring an automatic driving control amount on the basis of the plurality of pieces of vehicle surrounds information acquired by the information acquisition unit 11 and the machine learning model 13, and outputting the automatic driving control amount; the monitoring unit 14 for determining whether or not reliability of any one of the plurality of pieces of vehicle surrounds information acquired by the information acquisition unit 11 has decreased; and the control unit 15 for controlling, when the monitoring unit 14 determines that the reliability of any one of the plurality of pieces of vehicle surrounds information has decreased, the control amount inferring unit 12 in such a way as to output the automatic driving control amount excluding an influence of the one of the plurality of pieces of vehicle surrounds information whose reliability is determined to be decreased.

Therefore, the automatic driving control device 1 for inferring and outputting an automatic driving control amount, on the basis of the plurality of pieces of vehicle surrounds information output from the plurality of respective sensors and the machine learning model 13, can output an automatic driving control amount suitable for automatic driving control of the vehicle 100 even when the reliability of any one of the plurality of pieces of vehicle surrounds information has decreased.

More specifically, in the automatic driving control device 1 according to the first embodiment, the control amount inferring unit 12 includes: the first control amount inferring unit 121 for inferring the first automatic driving control amount on the basis of all of the plurality of pieces of vehicle surrounds information acquired by the information acquisition unit 11 and the first machine learning model 131; and the second control amount inferring unit 122 for inferring the second automatic driving control amount on the basis of a part of the plurality of pieces of vehicle surrounds information acquired by the information acquisition unit 11 and the second machine learning model 132, and the control unit 15 controls the control amount inferring unit 12 in such a way as to output the second automatic driving control amount when the monitoring unit 14 determines that the reliability of a piece of vehicle surrounds information other than the part of the plurality of pieces of vehicle surrounds information input to the second machine learning model 132 among the plurality of pieces of vehicle surrounds information has decreased. Therefore, the automatic driving control device 1 for inferring and outputting an automatic driving control amount, on the basis of the plurality of pieces of vehicle surrounds information output from the plurality of respective sensors and the machine learning model 13, can output an automatic driving control amount suitable for automatic driving control of the vehicle 100 even when the reliability of any one of the plurality of pieces of vehicle surrounds information has decreased.

### Second Embodiment

The first embodiment is on the premise that substantially no problem occurs in vehicle surrounds information output from one or more sensors among the plurality of sensors, while a problem relatively easily occurs in vehicle surrounds information output from one or more other sensors among the plurality of sensors. Specifically, the first embodiment is on the premise that, out of the camera 21 and the millimeter wave radar 22 included in the sensors, substantially no problem occurs in a captured image output from the camera 21, while a problem relatively easily occurs in distance information output from the millimeter wave radar 22.

A second embodiment is on the premise that at least one of the plurality of sensors is the camera 21. In addition, an embodiment which is on the premise that all of the plurality of sensors have a negligibly low possibility of breakdown, while a problem relatively easily occurs in a captured image output from the camera 21 due to an influence of weather, for example, and in which an automatic driving control device 1 infers an automatic driving control amount suitable for automatic driving control of the vehicle 100 even when the reliability of the captured image has decreased will be described.

Like the automatic driving control device 1 according to the first embodiment, the automatic driving control device 1a according to the second embodiment is assumed to be mounted on the vehicle 100.

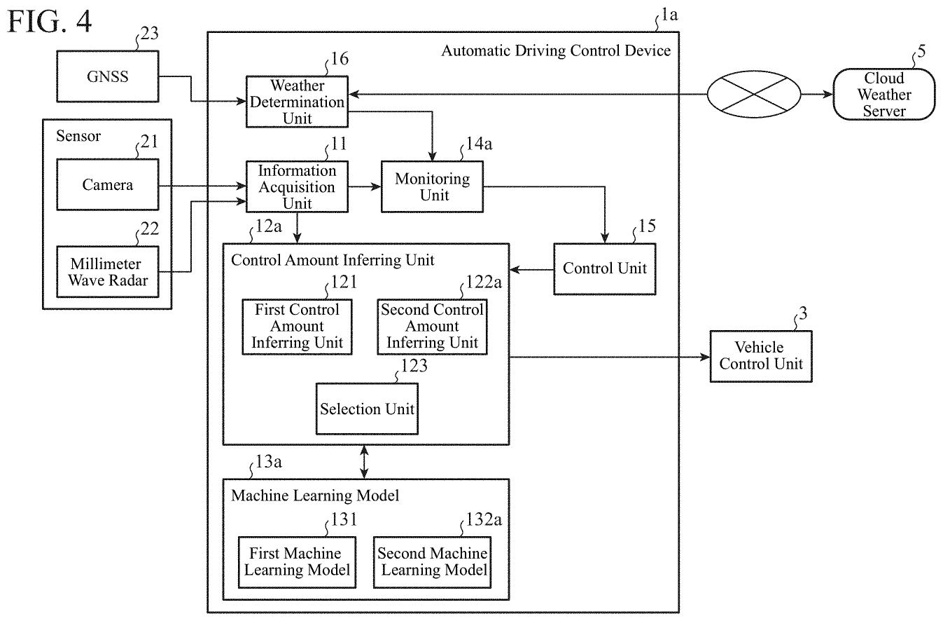

In the second embodiment, as illustrated in FIG. 4 described later, the camera 21 and the millimeter wave radar 22 are used as sensors. As described above, the second embodiment is on the premise that both the camera 21 and the millimeter wave radar 22 have a negligibly low possibility of breakdown, while a problem relatively easily occurs in a captured image output from the camera 21 due to an influence of weather, for example.

As in the first embodiment, the automatic driving control device 1a acquires the captured image output from the camera 21 and distance information output from the millimeter wave radar 22 as vehicle surrounds information. In addition, in the second embodiment, a global navigation satellite system (GNSS) 23 is mounted on the vehicle 100, and the automatic driving control device 1a acquires information regarding the current position of the vehicle 100 output from the GNSS 23 as information for determining whether or not the reliability of the captured image has decreased.

FIG. 4 is a diagram illustrating a configuration example of the automatic driving control device 1a according to the second embodiment.

In the automatic driving control device 1a according to the second embodiment, the same components as those of the automatic driving control device 1 described with reference to FIG. 2 in the first embodiment are denoted by the same reference numerals, and redundant description is omitted. The configuration of the automatic driving control device 1a according to the second embodiment is different from that of the automatic driving control device 1 according to the first embodiment in that the automatic driving control device 1a includes a weather determination unit 16. In addition, specific operations of a second control amount inferring unit 122a of a control amount inferring unit 12a and a monitoring unit 14a are different from those of the second control amount inferring unit 122 and the monitoring unit 14 of the automatic driving control device 1 according to the first embodiment.

As described above, the second embodiment is on the premise that a problem relatively easily occurs in the captured image output from the camera 21. Therefore, in order to prepare for a case where the reliability of the captured image has decreased, a second machine learning model 132a according to the second embodiment outputs a second automatic driving control amount by receiving distance information acquired by the information acquisition unit 11 from the millimeter wave radar 22 as input. The second control amount inferring unit 122a infers the second automatic driving control amount on the basis of the distance information acquired by the information acquisition unit 11 from the millimeter wave radar 22 and the second machine learning model 132a.

The information acquisition unit 11 acquires a captured image captured by the camera 21 and distance information measured by the millimeter wave radar 22 as vehicle surrounds information. The information acquisition unit 11 outputs the acquired vehicle surrounds information to the control amount inferring unit 12a and the monitoring unit 14a.

The weather determination unit 16 acquires information regarding the current position of the vehicle 100 from the GNSS 23. In addition, the weather determination unit 16 acquires weather information from a cloud weather server 5 described later via a network such as the Internet. The weather determination unit 16 determines weather around the vehicle 100 on the basis of the information regarding the current position of the vehicle 100 acquired from the GNSS 23 and the weather information acquired from the cloud weather server 5. For example, the weather determination unit 16 determines whether or not there is fog or precipitation around the vehicle 100.

Here, a state in which there is fog or precipitation as determined by the weather determination unit 16 is a state of dense fog or heavy precipitation in which the reliability of the captured image output from the camera 21 has decreased to an extent unsuitable for inference of an automatic driving control amount. Even in a case where the camera 21 itself is not broken, when there is dense fog or heavy precipitation around the vehicle 100, other vehicles and the like present around the vehicle 100 are not necessarily captured clearly in the captured image output from the camera 21. Therefore, such a captured image is not suitable for inference of an automatic driving control amount.

Note that an area around the vehicle 100 for which the weather determination unit 16 determines whether or not there is fog or precipitation is determined in advance, for example, within 1 km around the current position of the vehicle 100.

The cloud weather server 5 is a server for distributing information regarding weather conditions.

The weather determination unit 16 outputs information regarding the determined weather around the vehicle 100 to the monitoring unit 14a.

The monitoring unit 14a determines whether or not the reliability of the captured image output from the camera 21 has decreased on the basis of the information regarding weather output from the weather determination unit 16.

Specifically, for example, when the weather determination unit 16 determines that there is fog or precipitation around the vehicle 100, the monitoring unit 14a determines that the reliability of the captured image obtained from the camera 21 has decreased.

An operation of the automatic driving control device 1a according to the second embodiment will be described.

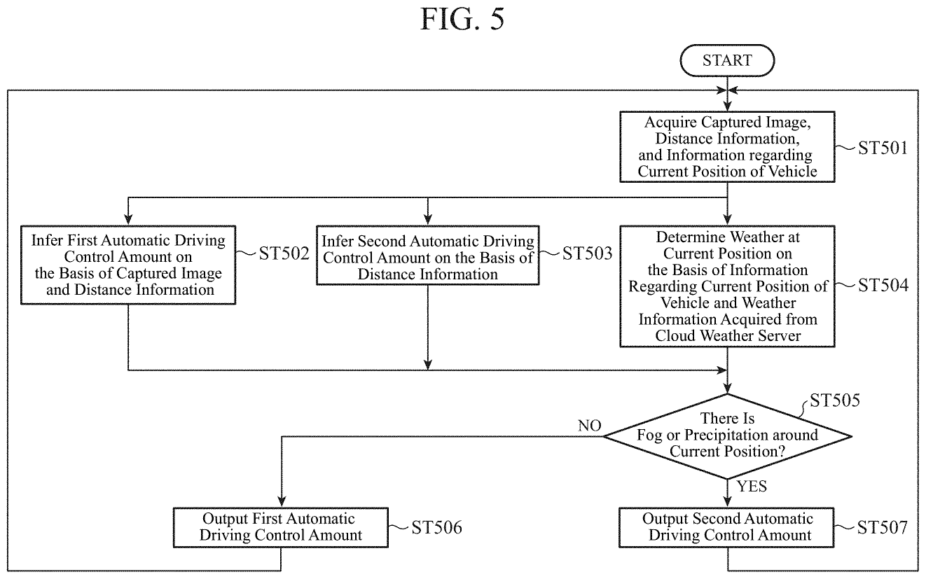

FIG. 5 is a flowchart for explaining the operation of the automatic driving control device 1a according to the second embodiment.

The information acquisition unit 11 acquires a plurality of pieces of vehicle surrounds information output from the plurality of respective sensors. Specifically, the information acquisition unit 11 acquires a captured image captured by the camera 21 and distance information measured by the millimeter wave radar 22 as vehicle surrounds information. In addition, the weather determination unit 16 acquires information regarding the current position of the vehicle 100 from the GNSS 23 (step ST501). The information acquisition unit 11 outputs the acquired vehicle surrounds information to the control amount inferring unit 12a and the monitoring unit 14a.

The first control amount inferring unit 121 of the control amount inferring unit 12a infers the first automatic driving control amount on the basis of all of the plurality of pieces of vehicle surrounds information acquired by the information acquisition unit 11 in step ST501 and the first machine learning model 131. Specifically, the first control amount inferring unit 121 infers the first automatic driving control amount on the basis of the captured image acquired by the information acquisition unit 11 from the camera 21 in step ST501, the distance information acquired by the information acquisition unit 11 from the millimeter wave radar 22 in step ST501, and the first machine learning model 131 (step ST502). The first control amount inferring unit 121 outputs the inferred first automatic driving control amount to the selection unit 123.

The second control amount inferring unit 122a of the control amount inferring unit 12a infers the second automatic driving control amount on the basis of a part of the plurality of pieces of vehicle surrounds information acquired by the information acquisition unit 11 in step ST501 and the second machine learning model 132a. Specifically, the second control amount inferring unit 122a infers the second automatic driving control amount on the basis of the distance information acquired by the information acquisition unit 11 from the millimeter wave radar 22 in step ST501 and the second machine learning model 132a (step ST503).

The second control amount inferring unit 122a outputs the inferred second automatic driving control amount to the selection unit 123.

The weather determination unit 16 determines weather around the vehicle 100 on the basis of the information regarding the current position of the vehicle 100 acquired from the GNSS 23 and weather information acquired from the cloud weather server 5 (step ST504). The weather determination unit 16 outputs information regarding the determined weather around the vehicle 100 to the monitoring unit 14a.

The monitoring unit 14a determines whether or not the reliability of the captured image obtained from the camera 21 has decreased on the basis of the information regarding weather output from the weather determination unit 16 in step ST504.

Specifically, the monitoring unit 14a determines, for example, whether or not there is fog or precipitation around the vehicle 100 on the basis of the information regarding weather output from the weather determination unit 16 (step ST505).

If it is determined in step ST505 that there is no fog or precipitation around the vehicle 100 (“NO” in step ST505), the monitoring unit 14a determines that the reliability of the captured image acquired from the camera 21 has not decreased, and outputs monitoring result information indicating that the reliability of the captured image has not decreased to the control unit 15.

The control unit 15 controls the control amount inferring unit 12a in such a way as to output the first automatic driving control amount inferred by the first control amount inferring unit 121 in step ST502. The selection unit 123 selects the first automatic driving control amount and outputs the first automatic driving control amount to the vehicle control unit 3 (step ST506).

If it is determined in step ST505 that there is fog or precipitation around the vehicle 100 (“YES” in step ST505), the monitoring unit 14a determines that the reliability of the captured image acquired from the camera 21 has decreased, and outputs monitoring result information indicating that the reliability of the captured image has decreased to the control unit 15.

The control unit 15 controls the control amount inferring unit 12a in such a way as to output the second automatic driving control amount inferred by the second control amount inferring unit 122a in step ST503. The selection unit 123 selects the second automatic driving control amount and outputs the second automatic driving control amount to the vehicle control unit 3 (step ST507).

After the operation in step ST506 or step ST507 is performed, the operation of the automatic driving control device 1a returns to step ST501, and the subsequent operations are repeated.

Regarding the operations described above, the process in which the weather determination unit 16 acquires information regarding the current position of the vehicle 100 from the GNSS 23 (see step ST501 in FIG. 5) and the process in which the weather determination unit 16 determines weather around the vehicle 100 on the basis of the information regarding the current position of the vehicle 100 acquired from the GNSS 23 and the weather information acquired from the cloud weather server 5 (see steps ST504 and ST505 in FIG. 5) do not necessarily have to be performed every time. For example, each of the processes may be performed only once per minute while the processes in steps ST501 to ST507 described above are performed. When the weather determination unit 16 does not perform the process of determining weather around the vehicle 100 on the basis of the position information of the vehicle 100 and the weather information every time, the weather determination unit 16 determines weather around the vehicle 100 on the basis of the latest weather information acquired from the cloud weather server 5.

As described above, the automatic driving control device 1a according to the second embodiment determines that the reliability of the captured image captured by the camera 21 has decreased under a weather condition of dense fog or heavy precipitation in which the reliability of the captured image output from the camera 21 has decreased to an extent unsuitable for inference of an automatic driving control amount. When determining that the reliability of the captured image has decreased, the automatic driving control device 1a can continuously perform inference of an automatic driving control amount without using the captured image output from the camera 21.

Note that in the second embodiment, at least one of the plurality of sensors used to acquire vehicle surrounds information only needs to be the camera 21, and a sensor other than the camera 21 is not limited to the millimeter wave radar 22 described above.

However, as the sensor other than the camera 21, it is necessary to use a sensor in which the reliability of vehicle surrounds information output from the sensor does not decrease under a weather condition in which the reliability of the captured image output from the camera 21 decreases.

In addition, in the above-described second embodiment, in the automatic driving control device 1a, before the monitoring unit 14a determines whether or not the reliability of the captured image has decreased (see step ST505 in FIG. 5), the first control amount inferring unit 121 and the second control amount inferring unit 122a infer the first automatic driving control amount and the second automatic driving control amount, respectively (see steps ST502 and ST503 in FIG. 5). However, this is merely an example, and the first control amount inferring unit 121 or the second control amount inferring unit 122a may infer an automatic driving control amount in response to determination by the monitoring unit 14a as to whether or not the reliability of the captured image has decreased. Specifically, for example, when the monitoring unit 14a determines that the reliability of the captured image has decreased, the control unit 15 controls the control amount inferring unit 12a in such a way as to output the second automatic driving control amount. When the control amount inferring unit 12a is controlled by the control unit 15 in such a way as to output the second automatic driving control amount, the second control amount inferring unit 122a infers the second automatic driving control amount. Meanwhile, when the monitoring unit 14a determines that the reliability of the captured image has not decreased, the control unit 15 controls the control amount inferring unit 12a in such a way as to output the first automatic driving control amount. When the control amount inferring unit 12a is controlled by the control unit 15 in such a way as to output the first automatic driving control amount, the first control amount inferring unit 121 infers the first automatic driving control amount. The control amount inferring unit 12a outputs the first automatic driving control amount inferred by the first control amount inferring unit 121 or the second automatic driving control amount inferred by the second control amount inferring unit 122a to the vehicle control unit 3 on the basis of the control of the control unit 15. In such a configuration, the automatic driving control device 1a can exclude the selection unit 123.

As described above, according to the second embodiment, the automatic driving control device 1a includes: the information acquisition unit 11 for acquiring a plurality of pieces of vehicle surrounds information output from a plurality of respective sensors (the camera 21 and the millimeter wave radar 22); the control amount inferring unit 12a for inferring an automatic driving control amount on the basis of the plurality of pieces of vehicle surrounds information acquired by the information acquisition unit 11 and the machine learning model 13a, and outputting the automatic driving control amount; the monitoring unit 14a for determining whether or not the reliability of any one of the plurality of pieces of vehicle surrounds information acquired by the information acquisition unit 11 has decreased; and the control unit 15 for controlling, when the monitoring unit 14a determines that the reliability of any one of the plurality of pieces of vehicle surrounds information has decreased, the control amount inferring unit 12a in such a way as to output the automatic driving control amount excluding an influence of the one of the plurality of pieces of vehicle surrounds information whose reliability is determined to be decreased.

Therefore, the automatic driving control device 1a for inferring and outputting an automatic driving control amount, on the basis of the plurality of pieces of vehicle surrounds information output from the plurality of respective sensors and the machine learning model 13a, can output an automatic driving control amount suitable for automatic driving control of the vehicle 100 even when the reliability of any one of the plurality of pieces of vehicle surrounds information has decreased.

More specifically, in the automatic driving control device 1a according to the second embodiment, the control amount inferring unit 12a includes: the first control amount inferring unit 121 for inferring the first automatic driving control amount on the basis of all of the plurality of pieces of vehicle surrounds information acquired by the information acquisition unit 11 and the first machine learning model 131; and the second control amount inferring unit 122a for inferring the second automatic driving control amount on the basis of a part of the plurality of pieces of vehicle surrounds information acquired by the information acquisition unit 11 and the second machine learning model 132a, and the control unit 15 controls the control amount inferring unit 12a in such a way as to output the second automatic driving control amount when the monitoring unit 14a determines that the reliability of a piece of vehicle surrounds information other than the part of the plurality of pieces of vehicle surrounds information input to the second machine learning model 132a among the plurality of pieces of vehicle surrounds information has decreased. Therefore, the automatic driving control device 1a for inferring and outputting an automatic driving control amount, on the basis of the plurality of pieces of vehicle surrounds information output from the plurality of respective sensors and the machine learning model 13a, can output an automatic driving control amount suitable for automatic driving control of the vehicle 100 even when the reliability of any one of the plurality of pieces of vehicle surrounds information has decreased.

### Third Embodiment

In the second embodiment, it is assumed that at least one of the plurality of sensors is the camera 21. In addition, the second embodiment is on the premise that all of the plurality of sensors have a negligibly low possibility of breakdown, while a problem relatively easily occurs in a captured image output from the camera 21 due to an influence of weather, for example. In addition, the embodiment has been described in which the automatic driving control device 1a determines whether or not the reliability of the captured image output from the camera 21 has decreased on the basis of weather around the vehicle 100, and infers an automatic driving control amount suitable for automatic driving control of the vehicle 100 even when the reliability of the captured image has decreased.

In a third embodiment, an embodiment will be described in which an automatic driving control device 1b determines whether or not the reliability of the captured image output from the camera 21 has decreased by a method different from that in the second embodiment.

Like the automatic driving control device 1 according to the first embodiment, the automatic driving control device 1b according to the third embodiment is assumed to be mounted on the vehicle 100.

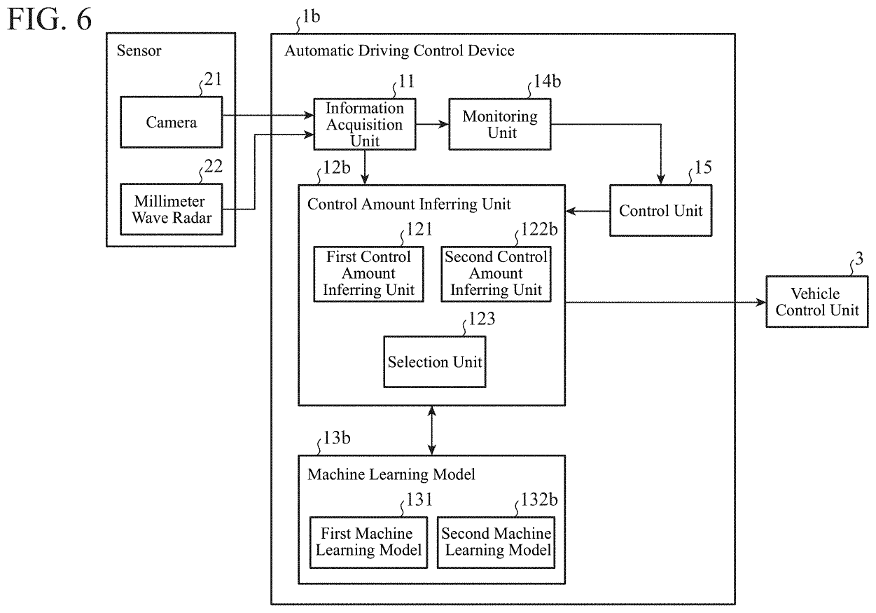

In the third embodiment, as illustrated in FIG. 6 described later, the camera 21 and the millimeter wave radar 22 are used as sensors. Like the above, the third embodiment is on the premise that both the camera 21 and the millimeter wave radar 22 have a negligibly low possibility of breakdown, while a problem relatively easily occurs in the captured image output from the camera 21.

FIG. 6 is a diagram illustrating a configuration example of the automatic driving control device 1b according to the third embodiment.

In the automatic driving control device 1b according to the third embodiment, the same components as those of the automatic driving control device 1 described with reference to FIG. 2 in the first embodiment are denoted by the same reference numerals, and redundant description is omitted. In the automatic driving control device 1b according to the third embodiment, specific operations of a second control amount inferring unit 122b of a control amount inferring unit 12b and a monitoring unit 14b are different from those of the second control amount inferring unit 122 and the monitoring unit 14 of the automatic driving control device 1 according to the first embodiment.

As described above, the third embodiment is on the premise that a problem relatively easily occurs in the captured image output from the camera 21. Therefore, in order to prepare for a case where the reliability of the captured image has decreased, a second machine learning model 132b according to the third embodiment outputs the second automatic driving control amount by receiving distance information acquired by the information acquisition unit 11 from the millimeter wave radar 22 as input. The second control amount inferring unit 122b infers the second automatic driving control amount on the basis of the distance information acquired by the information acquisition unit 11 from the millimeter wave radar 22 and the second machine learning model 132b.

The monitoring unit 14b determines whether or not the reliability of the captured image has decreased on the basis of luminance of the captured image acquired by the information acquisition unit 11.

Specifically, for example, when a maximum luminance value of pixels of the captured image acquired by the information acquisition unit 11 is equal to or smaller than a preset threshold (hereinafter, referred to as “luminance determination threshold”), the monitoring unit 14b determines that the reliability of the captured image obtained from the camera 21 has decreased. When all pixels of the captured image have luminance values equal to or smaller than the luminance determination threshold, the entire captured image is such a dark image that objects cannot be identified. The luminance determination threshold is set to such a luminance value in advance, for example.

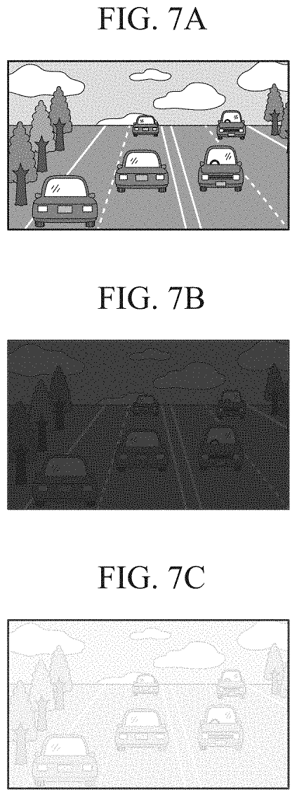

Here, FIG. 7 shows diagrams for explaining examples of captured images having different pixel luminance values in the third embodiment. FIG. 7A is an example of a captured image when all pixels of a captured image have luminance at which objects in the captured image can be sufficiently identified, FIG. 7B is an example of a captured image when all pixels of a captured image have luminance which causes such a dark image that objects in the captured image cannot be recognized, and FIG. 7C is an example of a captured image when all pixels of a captured image have luminance which causes such a bright image that objects in the captured image cannot be recognized.

For example, in the captured image, when the luminance of a black pixel is defined as “0” and the luminance of a white pixel is defined as “255”, “5” is set as the luminance determination threshold.

Note that, as illustrated in FIG. 7C, even when the captured image is too bright, objects in the captured image cannot be recognized. Therefore, for example, the luminance determination threshold may be set, in advance, to a luminance value which causes the following situation. When all pixels of the captured image have luminance values equal to or larger than the luminance determination threshold, the entire captured image is such a bright image that objects cannot be identified. In this case, when a minimum luminance value of pixels of the captured image acquired by the information acquisition unit 11 is equal to or larger than the luminance determination threshold, the monitoring unit 14b determines that the reliability of the captured image obtained from the camera 21 has decreased. For example, in the captured image, when the luminance of a black pixel is defined as “0” and the luminance of a white pixel is defined as “255”, “250” is set as the luminance determination threshold.

An operation of the automatic driving control device 1b according to the third embodiment will be described.

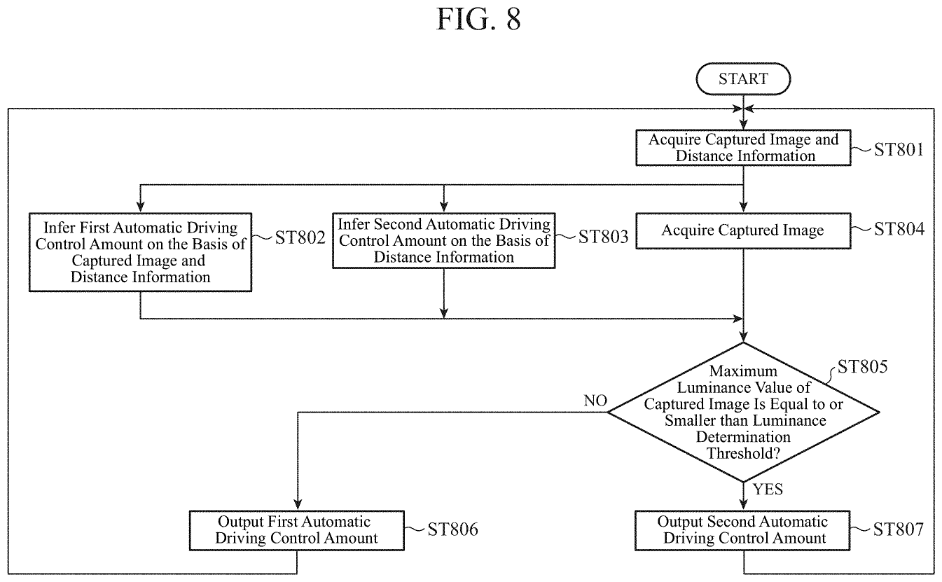

FIG. 8 is a flowchart for explaining the operation of the automatic driving control device 1b according to the third embodiment.

The information acquisition unit 11 acquires a plurality of pieces of vehicle surrounds information output from the plurality of respective sensors. Specifically, the information acquisition unit 11 acquires the captured image captured by the camera 21 and the distance information measured by the millimeter wave radar 22 as vehicle surrounds information (step ST801). The information acquisition unit 11 outputs the acquired vehicle surrounds information to the control amount inferring unit 12b and the monitoring unit 14b.

The first control amount inferring unit 121 of the control amount inferring unit 12b infers the first automatic driving control amount on the basis of all of the plurality of pieces of vehicle surrounds information acquired by the information acquisition unit 11 in step ST801 and the first machine learning model 131. Specifically, the first control amount inferring unit 121 infers the first automatic driving control amount on the basis of the captured image acquired by the information acquisition unit 11 from the camera 21 in step ST801, the distance information acquired by the information acquisition unit 11 from the millimeter wave radar 22 in step ST801, and the first machine learning model 131 (step ST802). The first control amount inferring unit 121 outputs the inferred first automatic driving control amount to the selection unit 123.

The second control amount inferring unit 122b of the control amount inferring unit 12 infers the second automatic driving control amount on the basis of a part of the plurality of pieces of vehicle surrounds information acquired by the information acquisition unit 11 in step ST801 and the second machine learning model 132b. Specifically, the second control amount inferring unit 122b infers the second automatic driving control amount on the basis of the distance information acquired by the information acquisition unit 11 from the millimeter wave radar 22 in step ST801 and the second machine learning model 132b (step ST803). The second control amount inferring unit 122b outputs the inferred second automatic driving control amount to the selection unit 123.

The monitoring unit 14b determines whether or not the reliability of any one of the plurality of pieces of vehicle surrounds information acquired by the information acquisition unit 11 has decreased. Specifically, first, the monitoring unit 14b acquires the captured image acquired by the information acquisition unit 11 from the camera 21 in step ST801 (step ST804).

Then, the monitoring unit 14b determines whether or not a maximum luminance value of pixels of the captured image acquired in step ST804 is equal to or smaller than the luminance determination threshold (step ST805).

If it is determined in step ST805 that the maximum luminance value of pixels of the captured image is larger than the luminance determination threshold (“NO” in step ST805), the monitoring unit 14b determines that the reliability of the captured image acquired from the camera 21 has not decreased, and outputs monitoring result information indicating that the reliability of the captured image has not decreased to the control unit 15.

The control unit 15 controls the control amount inferring unit 12b in such a way as to output the first automatic driving control amount inferred by the first control amount inferring unit 121 in step ST802. The selection unit 123 selects the first automatic driving control amount and outputs the first automatic driving control amount to the vehicle control unit 3 (step ST806).

If it is determined in step ST805 that the maximum luminance value of pixels of the image is equal to or smaller than the luminance determination threshold (“YES” in step ST805), the monitoring unit 14b determines that the reliability of the captured image acquired from the camera 21 has decreased, and outputs monitoring result information indicating that the reliability of the captured image has decreased to the control unit 15.

The control unit 15 controls the control amount inferring unit 12b in such a way as to output the second automatic driving control amount inferred by the second control amount inferring unit 122b in step ST803. The selection unit 123 selects the second automatic driving control amount and outputs the second automatic driving control amount to the vehicle control unit 3 (step ST807).

After the operation in step ST806 or step ST807 is performed, the operation of the automatic driving control device 1b returns to step ST801, and the subsequent operations are repeated.

As described above, the automatic driving control device 1b according to the third embodiment determines that the reliability of the captured image captured by the camera 21 has decreased when the captured image output from the camera 21 has luminance at which objects in the captured image cannot be recognized, and which causes the reliability of the captured image to decrease to an extent unsuitable for inference of an automatic driving control amount. When determining that the reliability of the captured image has decreased, the automatic driving control device 1b can continuously infer an automatic driving control amount without using the captured image. The captured image having luminance at which objects in the captured image cannot be recognized refers to, for example, a captured image captured in a completely dark situation, a situation in which an exposure correction function of the camera 21 is malfunctioning, or a situation in which an image cannot be captured due to a shielding object in front of the camera 21. In such a situation, the captured image acquired by the automatic driving control device 1b from the camera 21 is, for example, such a dark image that objects in the captured image cannot be recognized or such a bright image that objects in the captured image cannot be recognized.

Note that in the third embodiment, at least one of the plurality of sensors used to acquire vehicle surrounds information only needs to be the camera 21, and a sensor other than the camera 21 is not limited to the millimeter wave radar 22 described above.

As described above, according to the third embodiment, the automatic driving control device 1b includes: the information acquisition unit 11 for acquiring a plurality of pieces of vehicle surrounds information output from a plurality of respective sensors (the camera 21 and the millimeter wave radar 22); the control amount inferring unit 12b for inferring an automatic driving control amount on the basis of the plurality of pieces of vehicle surrounds information acquired by the information acquisition unit 11 and the machine learning model 13b, and outputting the automatic driving control amount; the monitoring unit 14b for determining whether or not the reliability of any one of the plurality of pieces of vehicle surrounds information acquired by the information acquisition unit 11 has decreased; and the control unit 15 for controlling, when the monitoring unit 14b determines that the reliability of any one of the plurality of pieces of vehicle surrounds information has decreased, the control amount inferring unit 12b in such a way as to output the automatic driving control amount excluding an influence of the one of the plurality of pieces of vehicle surrounds information whose reliability is determined to be decreased.

Therefore, the automatic driving control device 1b for inferring and outputting an automatic driving control amount, on the basis of the plurality of pieces of vehicle surrounds information output from the plurality of respective sensors and the machine learning model 13b, can output an automatic driving control amount suitable for automatic driving control of the vehicle 100 even when the reliability of any one of the plurality of pieces of vehicle surrounds information has decreased.

More specifically, in the automatic driving control device 1b according to the third embodiment, the control amount inferring unit 12b includes: the first control amount inferring unit 121 for inferring the first automatic driving control amount on the basis of all of the plurality of pieces of vehicle surrounds information acquired by the information acquisition unit 11 and the first machine learning model 131; and the second control amount inferring unit 122b for inferring the second automatic driving control amount on the basis of a part of the plurality of pieces of vehicle surrounds information acquired by the information acquisition unit 11 and the second machine learning model 132b, and the control unit 15 controls the control amount inferring unit 12b in such a way as to output the second automatic driving control amount when the monitoring unit 14b determines that the reliability of a piece of vehicle surrounds information other than the part of the plurality of pieces of vehicle surrounds information input to the second machine learning model 132b among the plurality of pieces of vehicle surrounds information has decreased. Therefore, the automatic driving control device 1b for inferring and outputting an automatic driving control amount, on the basis of the plurality of pieces of vehicle surrounds information output from the plurality of respective sensors and the machine learning model 13b, can output an automatic driving control amount suitable for automatic driving control of the vehicle 100 even when the reliability of any one of the plurality of pieces of vehicle surrounds information has decreased.

### Fourth Embodiment

In the second and third embodiments, it is assumed that at least one of the plurality of sensors is the camera 21. In addition, the second and third embodiments are on the premise that all of the plurality of sensors have a negligibly low possibility of breakdown, while a problem relatively easily occurs in a captured image output from the camera 21. In addition, the embodiments have been described in which each of the automatic driving control device 1a and 1b determines whether or not the reliability of the captured image output from the camera 21 has decreased on the basis of weather around the vehicle 100 or the luminance of the pixels of the captured image, and infers an automatic driving control amount suitable for automatic driving control of the vehicle 100 even when the reliability of the captured image has decreased.

In a fourth embodiment, an embodiment will be described in which an automatic driving control device 1c determines whether or not the reliability of the captured image output from the camera 21 has decreased by a method different from those in the second and third embodiments.

Like the automatic driving control devices 1 according to the first to third embodiments, the automatic driving control device 1c according to the fourth embodiment is assumed to be mounted on the vehicle 100.

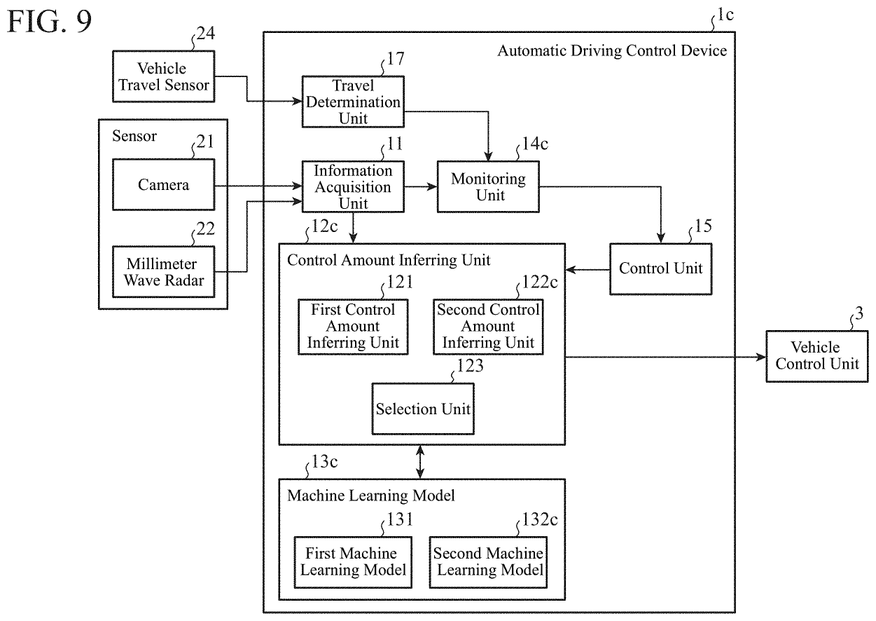

In the fourth embodiment, as illustrated in FIG. 9 described later, the camera 21 and the millimeter wave radar 22 are used as sensors. As in the second and third embodiments, also the fourth embodiment is on the premise that both the camera 21 and the millimeter wave radar 22 have a negligibly low possibility of breakdown, while a problem relatively easily occurs in the captured image output from the camera 21.

As in the first to third embodiments, the automatic driving control device 1c acquires the captured image output from the camera 21 and distance information output from the millimeter wave radar 22 as vehicle surrounds information. In addition, in the fourth embodiment, the automatic driving control device 1c acquires information for determining whether or not the vehicle 100 is traveling (hereinafter, referred to as “vehicle travel information”) output from a vehicle travel sensor 24. In the fourth embodiment, “the vehicle 100 is traveling” is synonymous with “the vehicle 100 is moving”. “The vehicle 100 is moving” is synonymous with “the speed of the vehicle 100 is not “0””.

The vehicle travel sensor 24 outputs the vehicle travel information. The vehicle travel sensor 24 may be any sensor as long as the vehicle travel sensor 24 outputs information with which it can be determined whether or not the vehicle 100 is traveling, and thus the vehicle travel sensor 24 may be, for example, a sensor for acquiring the number of revolutions of wheels, or a GNSS for acquiring information regarding the current position of the vehicle 100.

Note that whether or not the vehicle 100 is traveling is determined by a travel determination unit 17 described later on the basis of the vehicle travel information output from the vehicle travel sensor 24.

FIG. 9 is a diagram illustrating a configuration example of the automatic driving control device 1c according to the fourth embodiment.

In the automatic driving control device 1c according to the fourth embodiment, the same components as those of the automatic driving control device 1 described with reference to FIG. 2 in the first embodiment are denoted by the same reference numerals, and redundant description is omitted. The configuration of the automatic driving control device 1c according to the fourth embodiment is different from that of the automatic driving control device 1 according to the first embodiment in that the automatic driving control device 1c includes the travel determination unit 17. In addition, in the automatic driving control device 1c according to the fourth embodiment, specific operations of a second control amount inferring unit 122c of a control amount inferring unit 12c and a monitoring unit 14c are different from specific operations of the second control amount inferring unit 122 and the monitoring unit 14 of the automatic driving control device 1 according to the first embodiment.

As described above, the fourth embodiment is on the premise that a problem relatively easily occurs in the captured image output from the camera 21. Therefore, in order to prepare for a case where the reliability of the captured image has decreased, a second machine learning model 132c according to the fourth embodiment outputs the second automatic driving control amount by receiving distance information acquired by the information acquisition unit 11 from the millimeter wave radar 22 as input. The second control amount inferring unit 122c infers the second automatic driving control amount on the basis of the distance information acquired by the information acquisition unit 11 from the millimeter wave radar 22 and the second machine learning model 132c.

The information acquisition unit 11 acquires a captured image captured by the camera 21 and distance information measured by the millimeter wave radar 22 as vehicle surrounds information. The information acquisition unit 11 outputs the acquired vehicle surrounds information to the control amount inferring unit 12c and the monitoring unit 14c.

The travel determination unit 17 determines whether or not the vehicle 100 is traveling on the basis of the vehicle travel information acquired from the vehicle travel sensor 24.

The travel determination unit 17 outputs the determined information regarding whether or not the vehicle 100 is traveling to the monitoring unit 14c.

The monitoring unit 14c determines whether or not the reliability of the captured image has decreased on the basis of the information regarding whether or not the vehicle 100 is traveling acquired from the travel determination unit 17 and the captured image acquired from the information acquisition unit 11. Specifically, the monitoring unit 14c determines whether the vehicle 100 is traveling and scenery around the vehicle 100 captured in the captured image acquired from the camera 21 has not changed. The monitoring unit 14c determines whether the scenery captured in the captured image has not changed on the basis of the captured image acquired from the information acquisition unit 11c and a captured image accumulated in a storage unit. For example, the monitoring unit 14c compares, for each pixel, the captured image acquired from the information acquisition unit 11 (referred to as a “first captured image”) with a captured image most recently stored in the storage unit (referred to as a “second captured image”), and determines that there is no change in the scenery captured in the first captured image when a result of the comparison indicates that a preset comparison condition is satisfied. The preset comparison condition is, for example, that an average of absolute values of differences between pixel values of pixels of the first captured image and pixel values of pixels of the second captured image is equal to or smaller than a preset threshold. Note that this is merely an example, and the comparison condition only needs to be set in such a manner that it can be determined that the first captured image and the second captured image are identical to each other. In the fourth embodiment, a fact that the first captured image and the second captured image are identical to each other is not limited to being completely identical to each other, but includes being substantially identical to each other.

When the vehicle 100 is traveling and the scenery around the vehicle 100 captured in the captured image has not changed, the monitoring unit 14c determines that the reliability of the captured image has decreased.

When the vehicle 100 is traveling, it is assumed that the scenery captured in the captured image changes. Therefore, a fact that there is no change in the scenery captured in the captured image even though the vehicle 100 is traveling means that the reliability of the captured image has decreased.

Note that in the fourth embodiment, in the automatic driving control device 1c, the information acquisition unit 11 causes the storage unit to accumulate the captured image acquired from the camera 21. The monitoring unit 14c determines whether there is no change in the scenery captured in the captured image on the basis of the captured image acquired from the information acquisition unit 11 and a captured image accumulated in the storage unit.

An operation of the automatic driving control device 1c according to the fourth embodiment will be described.

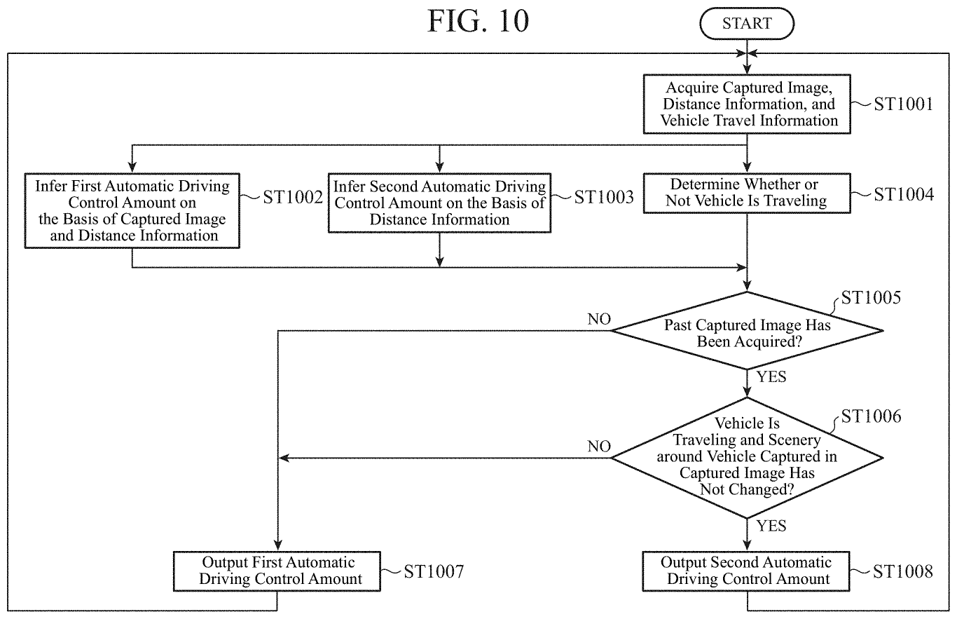

FIG. 10 is a flowchart for explaining the operation of the automatic driving control device 1c according to the fourth embodiment.

The information acquisition unit 11 acquires a plurality of pieces of vehicle surrounds information output from the plurality of respective sensors. Specifically, the information acquisition unit 11 acquires a captured image captured by the camera 21 and distance information measured by the millimeter wave radar 22 as vehicle surrounds information. In addition, the travel determination unit 17 acquires vehicle travel information from the vehicle travel sensor 24 (step ST1001). The information acquisition unit 11 outputs the acquired vehicle surrounds information to the control amount inferring unit 12c and the monitoring unit 14c.

The first control amount inferring unit 121 of the control amount inferring unit 12c infers the first automatic driving control amount on the basis of all of the plurality of pieces of vehicle surrounds information acquired by the information acquisition unit 11 in step ST1001 and the first machine learning model 131. Specifically, the first control amount inferring unit 121 infers the first automatic driving control amount on the basis of the captured image acquired by the information acquisition unit 11 from the camera 21 in step ST1001, the distance information acquired by the information acquisition unit 11 from the millimeter wave radar 22 in step ST1001, and the first machine learning model 131 (step ST1002). The first control amount inferring unit 121 outputs the inferred first automatic driving control amount to the selection unit 123.

The second control amount inferring unit 122c of the control amount inferring unit 12c infers the second automatic driving control amount on the basis of a part of the plurality of pieces of vehicle surrounds information acquired by the information acquisition unit 11c in step ST1001 and the second machine learning model 132c. Specifically, the second control amount inferring unit 122c infers the second automatic driving control amount on the basis of the distance information acquired by the information acquisition unit 11 from the millimeter wave radar 22 in step ST1001 and the second machine learning model 132c (step ST1003).

The second control amount inferring unit 122c outputs the inferred second automatic driving control amount to the selection unit 123.

The travel determination unit 17 determines whether or not the vehicle 100 is traveling on the basis of the vehicle travel information acquired from the vehicle travel sensor 24 (step ST1004). The travel determination unit 17 outputs the determined information regarding whether or not the vehicle 100 is traveling to the monitoring unit 14c.

The monitoring unit 14c determines whether or not a captured image acquired from the camera 21 in the past is accumulated in the storage unit (step ST1005).

If it is determined in step ST1005 that the captured image is not accumulated in the storage unit (“NO” in step ST1005), the monitoring unit 14c determines that the reliability of the captured image acquired from the camera 21 has not decreased, and outputs monitoring result information indicating that the reliability of the captured image has not decreased to the control unit 15. The operation of the automatic driving control device 1c proceeds to step ST1007.

If it is determined in step ST1005 that the captured image is accumulated in the storage unit (“YES” in step ST1005), the monitoring unit 14c determines whether or not the reliability of the captured image has decreased on the basis of the captured image output from the information acquisition unit 11 in step ST1001 and the information regarding whether or not the vehicle 100 is traveling, output from the travel determination unit 17 in step ST1004. Specifically, the monitoring unit 14c determines whether the vehicle 100 is traveling and scenery around the vehicle 100 captured in the captured image has not changed (step ST1006).

If the monitoring unit 14c determines in step ST1006 that the vehicle 100 is not traveling or that the scenery around the vehicle 100 captured in the captured image has changed (“NO” in step ST1006), the monitoring unit 14c determines that the reliability of the captured image acquired from the camera 21 has not decreased, and outputs monitoring result information indicating that the reliability of the captured image has not decreased to the control unit 15. The operation of the automatic driving control device 1c proceeds to step ST1007.

In step ST1007, the control unit 15 controls the control amount inferring unit 12c in such a way as to output the first automatic driving control amount inferred by the first control amount inferring unit 121 in step ST1002. The selection unit 123 selects the first automatic driving control amount and outputs the first automatic driving control amount to the vehicle control unit 3 (step ST1007).

Meanwhile, if it is determined in step ST1006 that the vehicle 100 is traveling and the scenery around the vehicle 100 captured in the captured image has not changed (“YES” in step ST1006), the monitoring unit 14c determines that the reliability of the captured image acquired from the camera 21 has decreased, and outputs monitoring result information indicating that the reliability of the captured image has decreased to the control unit 15.

The control unit 15 controls the control amount inferring unit 12c in such a way as to output the second automatic driving control amount inferred by the second control amount inferring unit 122c in step ST1003. The selection unit 123 selects the second automatic driving control amount and outputs the second automatic driving control amount to the vehicle control unit 3 (step ST1008).

After the operation in step ST1007 or step ST1008 is performed, the operation of the automatic driving control device 1c returns to step ST1001, and the subsequent operations are repeated.

As described above, the automatic driving control device 1c according to the fourth embodiment determines that the reliability of the captured image acquired from the camera 21 has decreased, when only a captured image in which a vehicle surrounds situation of the traveling vehicle 100 has not been appropriately captured, and from which the automatic driving control amount cannot be correctly inferred can be acquired. When determining that the reliability of the captured image has decreased, the automatic driving control device 1c can continuously infer an automatic driving control amount without using the captured image output from the camera 21.

Note that in the fourth embodiment, at least one of the plurality of sensors used to acquire vehicle surrounds information only needs to be the camera 21, and a sensor other than the camera 21 is not limited to the millimeter wave radar 22 described above.

As described above, according to the fourth embodiment, the automatic driving control device 1c includes: the information acquisition unit 11 for acquiring a plurality of pieces of vehicle surrounds information output from a plurality of respective sensors (the camera 21 and the millimeter wave radar 22); the control amount inferring unit 12c for inferring an automatic driving control amount on the basis of the plurality of pieces of vehicle surrounds information acquired by the information acquisition unit 11 and the machine learning model 13c, and outputting the automatic driving control amount; the monitoring unit 14c for determining whether or not the reliability of any one of the plurality of pieces of vehicle surrounds information acquired by the information acquisition unit 11 has decreased; and the control unit 15 for controlling, when the monitoring unit 14c determines that the reliability of any one of the plurality of pieces of vehicle surrounds information has decreased, the control amount inferring unit 12c in such a way as to output the automatic driving control amount excluding an influence of the one of the plurality of pieces of vehicle surrounds information whose reliability is determined to be decreased.

Therefore, the automatic driving control device 1c for inferring and outputting an automatic driving control amount, on the basis of the plurality of pieces of vehicle surrounds information output from the plurality of respective sensors and the machine learning model 13c, can output an automatic driving control amount suitable for automatic driving control of the vehicle 100 even when the reliability of any one of the plurality of pieces of vehicle surrounds information has decreased.

More specifically, in the automatic driving control device 1c according to the fourth embodiment, the control amount inferring unit 12c includes: the first control amount inferring unit 121 for inferring the first automatic driving control amount on the basis of all of the plurality of pieces of vehicle surrounds information acquired by the information acquisition unit 11 and the first machine learning model 131; and the second control amount inferring unit 122c for inferring the second automatic driving control amount on the basis of a part of the plurality of pieces of vehicle surrounds information acquired by the information acquisition unit 11 and the second machine learning model 132c, and the control unit 15 controls the control amount inferring unit 12c in such a way as to output the second automatic driving control amount when the monitoring unit 14c determines that the reliability of a piece of vehicle surrounds information other than the part of the plurality of pieces of vehicle surrounds information input to the second machine learning model 132c among the plurality of pieces of vehicle surrounds information has decreased. Therefore, the automatic driving control device 1c for inferring and outputting an automatic driving control amount, on the basis of the plurality of pieces of vehicle surrounds information output from the plurality of respective sensors and the machine learning model 13c, can output an automatic driving control amount suitable for automatic driving control of the vehicle 100 even when the reliability of any one of the plurality of pieces of vehicle surrounds information has decreased.

### Fifth Embodiment

When determining that the reliability of the vehicle surrounds information output from a sensor has decreased, the automatic driving control device 1 according to the first embodiment can output, outside the automatic driving control device 1, information indicating that the reliability has decreased.

In a fifth embodiment, an embodiment will be described in which when determining that the reliability of vehicle surrounds information output from a sensor has decreased, the automatic driving control device 1 outputs, outside the automatic driving control device 1, information indicating that the reliability has decreased.

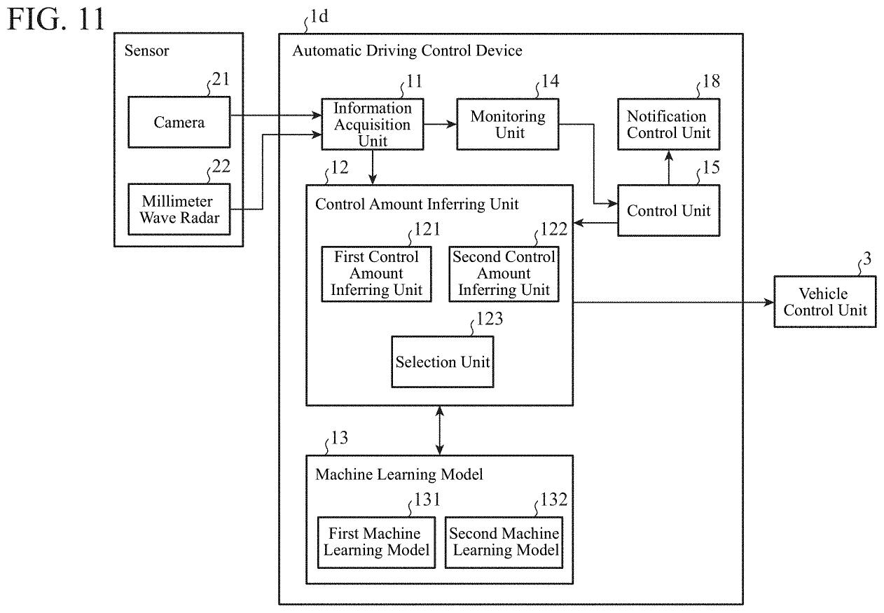

FIG. 11 is a diagram illustrating a configuration example of an automatic driving control device 1d according to the fifth embodiment.

In the automatic driving control device 1d according to the fifth embodiment, the same components as those of the automatic driving control device 1 described with reference to FIG. 2 in the first embodiment are denoted by the same reference numerals, and redundant description is omitted. The configuration of the automatic driving control device 1d according to the fifth embodiment is different from that of the automatic driving control device 1 according to the first embodiment in that the automatic driving control device 1d includes a notification control unit 18.

When the control unit 15 controls the control amount inferring unit 12 in such a way as to output the second automatic driving control amount, the notification control unit 18 outputs notification information indicating that the reliability of a part of the plurality of pieces of vehicle surrounds information has decreased. Specifically, when the monitoring unit 14 determines that the reliability of the distance information has decreased and thereby the control unit 15 controls the control amount inferring unit 12 in such a way as to output the second automatic driving control amount, the notification control unit 18 outputs notification information indicating that the reliability of the distance information output from the millimeter wave radar 22 has decreased. The notification control unit 18 outputs the notification information to an output device (not illustrated) connected to the automatic driving control device 1d via a network. The output device is, for example, a display included in a car navigation system mounted on the vehicle 100. The notification control unit 18 causes the display to display the notification information.

In the fourth embodiment, when the monitoring unit 14 determines that the reliability of a piece of vehicle surrounds information other than a part of the plurality of vehicle surrounds information has decreased, the control unit 15 performs control in such a way as to output the second automatic driving control amount and outputs information indicating that the reliability of the vehicle surrounds information has decreased to the notification control unit 18.

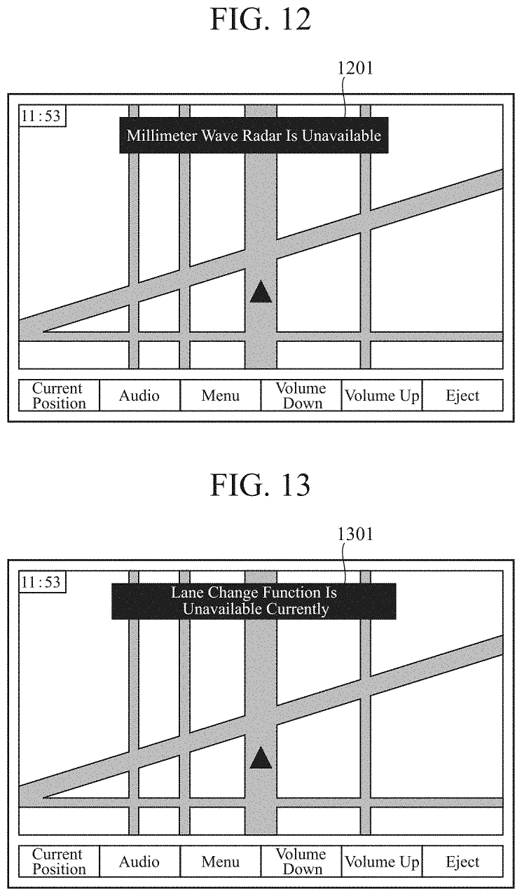

Here, each of FIGS. 12 and 13 is a diagram illustrating an example of a screen of the display that is caused to display the notification information by the notification control unit 18 in the fifth embodiment.

For example, as illustrated in FIG. 12, the notification control unit 18 causes the display to display a message “millimeter wave radar is unavailable” as information indicating that the reliability of the distance information output from the millimeter wave radar 22 has decreased (see 1201 in FIG. 12). As described above, the information indicating that the reliability of the distance information has decreased includes, for example, a message indicating that a sensor for outputting a piece of vehicle surrounds information whose reliability has decreased is unavailable.

In addition, for example, as illustrated in FIG. 13, the notification control unit 18 causes the display to display a message “a lane change function is unavailable currently” as information indicating that the reliability of the distance information output from the millimeter wave radar 22 has decreased (see 1301 in FIG. 13). As described above, the information indicating that the reliability of the distance information has decreased includes, for example, a message giving a notification of a function that is unavailable for automatic driving control of the vehicle 100 due to presence of vehicle surrounds information whose reliability is determined to be decreased. For example, when the distance information output from the millimeter wave radar 22 is unavailable in automatic driving control of the vehicle 100, a lane change cannot be performed.

An operation of the automatic driving control device 1d according to the fifth embodiment will be described.

Since the operation of the automatic driving control device 1d is basically the same as the operation described with reference to FIG. 3 in the first embodiment, a flowchart is not illustrated.

If it is determined in step ST305 that a difference between the reference distance acquired in step ST304 and a distance from the vehicle 100 to the object based on the distance information acquired by the information acquisition unit 11 from the millimeter wave radar 22 in step ST301 is larger than the radar determination threshold (“NO” in step ST305), the monitoring unit 14 determines that the reliability of the distance information acquired from the millimeter wave radar 22 has decreased, and outputs monitoring result information indicating that the reliability of the distance information has decreased to the control unit 15.

The control unit 15 controls the control amount inferring unit 12 in such a way as to output the second automatic driving control amount inferred by the second control amount inferring unit 122 in step ST303, and outputs information indicating that the reliability of the vehicle surrounds information has decreased to the notification control unit 18. The notification control unit 18 outputs notification information indicating that the reliability of a part of the plurality of pieces of vehicle surrounds information has decreased.

As described above, in the automatic driving control device 1d according to the fifth embodiment, when the control unit 15 controls the control amount inferring unit 12 in such a way as to output the second automatic driving control amount, the notification control unit 18 outputs notification information indicating that the reliability of a part of the plurality of pieces of vehicle surrounds information has decreased. As a result, the automatic driving control device 1d can notify a driver or the like of the vehicle 100 that the reliability of the part of the pieces of vehicle surrounds information has decreased. When confirming that the reliability of the part of the pieces of vehicle surrounds information has decreased, for example, the driver or the like checks whether an antenna of the millimeter wave radar 22 is not dirty, and cleans the antenna if the antenna is dirty. Alternatively, the driver or the like repairs the millimeter wave radar 22.

In addition, for example, when the notification control unit 18 outputs notification information as illustrated in FIG. 13, the automatic driving control device 1d according to the fifth embodiment can notify the driver or the like that an automatic driving function that can be inferred has been changed. As a result, the automatic driving control device 1d can cause the driver or the like to understand that an expected automatic driving function is unavailable, and thus can prevent the driver or the like from being confused about the fact that the expected automatic driving function is unavailable. Note that, as described above, the notification control unit 18 can also output notification information as illustrated in FIG. 12, but the driver or the like can specifically understand which function of automatic driving is unavailable when the driver or the like is notified of a function decrease in automatic driving control as illustrated in FIG. 13.

In the above-described fifth embodiment, as an example, the output device from which the notification control unit 18 outputs notification information is a display included in a car navigation system, but this is merely an example. For example, the output device from which the notification control unit 18 outputs notification information may be an instrument panel, and the notification control unit 18 may cause the instrument panel to display notification information as a message, an icon, or the like. In addition, the notification control unit 18 is not limited to displaying notification information, and may output the notification information by voice. Specifically, for example, the output device may be a voice output device such as a speaker, and the notification control unit 18 may output notification information from the voice output device. The notification control unit 18 may output notification information as an automatic voice or simply as a buzzer sound. In addition, the notification control unit 18 may cause the display to display notification information as a message and cause the notification information to be output as a voice or a buzzer sound.

In addition, the configuration of the automatic driving control device 1d according to the above-described fifth embodiment may be applied to the above-described second to fourth embodiments. That is, the automatic driving control device 1a according to the second embodiment, the automatic driving control device 1b according to the third embodiment, or the automatic driving control device 1c according to the fourth embodiment can include the notification control unit 18, and the notification control unit 18 can output information indicating that the reliability of the captured image acquired from the camera 21 has decreased.

As described above, according to the fifth embodiment, in addition to the components of the automatic driving control device 1 according to the first embodiment, the automatic driving control device 1d includes the notification control unit 18 for outputting notification information indicating that the reliability of a part of the plurality of pieces of vehicle surrounds information has decreased when the control unit 15 controls the control amount inferring unit 12 in such a way as to output the second automatic driving control amount. Therefore, when determining that the reliability of the vehicle surrounds information output from a sensor has decreased, the automatic driving control device 1d can notify a driver or the like that the reliability has decreased.

### Sixth Embodiment

The automatic driving control devices 1 to 1d according to the first to fifth embodiments use the first machine learning model 131 when there is no piece of vehicle surrounds information whose reliability has decreased among a plurality of pieces of vehicle surrounds information output from a plurality of sensors, and use the second machine learning models 132 and 132a to 132c when there is a piece of vehicle surrounds information whose reliability has decreased.

However, these are merely examples, and the automatic driving control device can use the same one machine learning model 13 for a plurality of pieces of vehicle surrounds information output from a plurality of sensors in a case where there is no piece of vehicle surrounds information whose reliability has decreased and in a case where there is a piece of vehicle surrounds information whose reliability has decreased. In a sixth embodiment, an embodiment will be described in which an automatic driving control device uses the same one machine learning model in the above two cases.

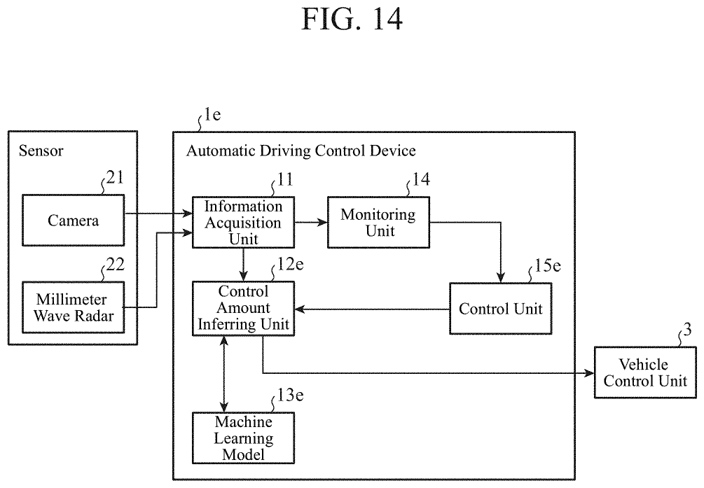

FIG. 14 is a diagram illustrating a configuration example of an automatic driving control device 1e according to the sixth embodiment.

Note that here, as an example, a configuration and an operation of the automatic driving control device 1e according to the sixth embodiment will be described on the assumption that a part of the configuration and the operation of the automatic driving control device 1 according to the first embodiment is changed. However, the configuration and the operation of the automatic driving control device 1e according to the sixth embodiment can also be implemented by partially changing the configuration and the operation of any one of the automatic driving control devices 1a to 1d according to the second to fifth embodiments.

In the automatic driving control device 1e according to the sixth embodiment, the same components as those of the automatic driving control device 1 described with reference to FIG. 2 in the first embodiment are denoted by the same reference numerals, and redundant description is omitted. The configuration of the automatic driving control device 1e according to the sixth embodiment is different from that of the automatic driving control device 1 according to the first embodiment in that a control amount inferring unit 12e does not include the first control amount inferring unit 121, the second control amount inferring unit 122, or the selection unit 123, and a machine learning model 13e does not include the first machine learning model 131 or the second machine learning model 132.

In addition, the automatic driving control device 1e according to the sixth embodiment is different from the automatic driving control device 1 according to the first embodiment in an operation of a control unit 15e.

The control unit 15e adds information effectiveness flags based on a determination result of reliability by the monitoring unit 14 to all of the plurality of pieces of vehicle surrounds information acquired by the information acquisition unit 11. The information effectiveness flag is information indicating whether each piece of vehicle surrounds information is effective or ineffective. That is, when the reliability of a certain piece of vehicle surrounds information has not decreased, an information effectiveness flag indicating that the piece of vehicle surrounds information is effective is added. In addition, when the reliability of a certain piece of vehicle surrounds information has decreased, an information effectiveness flag indicating that the piece of vehicle surrounds information is ineffective is added.

In the sixth embodiment, as illustrated in FIG. 14 described later, the camera 21 and the millimeter wave radar 22 are used as sensors similarly to the sensors of the first embodiment. In addition, similarly to the premise of the first embodiment, the sixth embodiment is on the premise that substantially no problem occurs in the captured image taken by the camera 21, while a problem relatively easily occurs in the distance information made by the millimeter wave radar 22.

Therefore, specifically, when the monitoring unit 14 determines that the reliability of the distance information output from the millimeter wave radar 22 has decreased, the control unit 15e adds an information effectiveness flag “1” to the captured image output from the camera 21, and adds an information effectiveness flag “0” to the distance information output from the millimeter wave radar 22. In the sixth embodiment, as an example, a case where the information effectiveness flag is “1” indicates that the reliability of a piece of vehicle surrounds information to which the information flag is added has not decreased, and a case where the information effectiveness flag is “0” indicates that the reliability of the piece of flagged vehicle surrounds information to which the information effectiveness flag is added has decreased.

Hereinafter, the vehicle surrounds information to which an information effectiveness flag is added is referred to as “flagged vehicle surrounds information”.

The control unit 15e outputs, to the control amount inferring unit 12e, a plurality of pieces of flagged vehicle surrounds information generated by adding information effectiveness flags to all of the plurality of pieces of vehicle surrounds information acquired by the information acquisition unit 11.

When acquiring the plurality of pieces of flagged vehicle surrounds information from the control unit 15e, the control amount inferring unit 12e infers an automatic driving control amount on the basis of all of the plurality of pieces of flagged vehicle surrounds information and the machine learning model 13e, and outputs the automatic driving control amount.

The machine learning model 13e receives all of the plurality of pieces of flagged vehicle surrounds information output from the control unit 15e as input, and thereby outputs an automatic driving control amount. The machine learning model 13e has learned in such a way as to be able to infer an automatic driving control amount by excluding an influence of the piece of vehicle surrounds information to which “0” is added as an information effectiveness flag among the plurality of pieces of flagged vehicle surrounds information. Such learning can be performed, for example, on the basis of training data including multiple pairs in each of which a plurality of pieces of flagged vehicle surrounds information that can be input to the machine learning model 13e is paired with a correct answer of an ideal automatic driving control amount derived in advance on the basis of only an effective piece of vehicle surrounds information among the plurality of pieces of flagged vehicle surrounds information.

By inferring an automatic driving control amount on the basis of the machine learning model 13e and the plurality of pieces of flagged vehicle surrounds information, the control amount inferring unit 12e can infer an automatic driving control amount excluding an influence of a piece of vehicle surrounds information whose reliability has decreased, and can output the automatic driving control amount. Here, “excluding an influence of a piece of vehicle surrounds information whose reliability has decreased” includes not only a state in which an influence of a piece of vehicle surrounds information whose reliability has decreased is completely removed, but also a state in which an influence of a piece of vehicle surrounds information whose reliability has decreased is substantially removed to an extent where an automatic driving control amount enabling continuation of automatic driving control can be acquired.

An operation of the automatic driving control device 1e according to the sixth embodiment will be described.

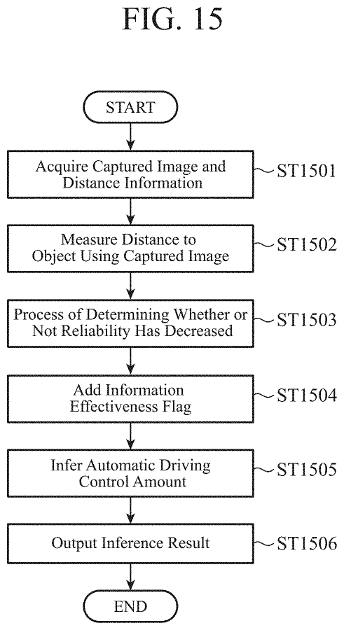

FIG. 15 is a flowchart for explaining the operation of automatic driving control device 1e according to the sixth embodiment.

Since specific operations in steps ST1501 and ST1502 in FIG. 15 are similar to those in steps ST301 and ST304 in FIG. 3 described in the first embodiment, redundant description is omitted.

The monitoring unit 14 performs a process of determining whether or not the reliability of the distance information acquired from the millimeter wave radar 22 has decreased (step ST1503). Specifically, the monitoring unit 14 calculates a difference between a reference distance acquired in step ST1502 and a distance from the vehicle 100 to the object based on the distance information acquired by the information acquisition unit 11 from the millimeter wave radar 22 in step ST1501, and determines whether or not the calculated difference is equal to or smaller than the radar determination threshold (step ST1503). A specific operation in step ST1503 is similar to that in step ST305 in FIG. 3 described in the first embodiment.

If it is determined that the calculated difference is larger than the radar determination threshold, the monitoring unit 14 determines that the reliability of the distance information acquired from the millimeter wave radar 22 has decreased, and outputs monitoring result information indicating that the reliability of the distance information has decreased to the control unit 15e.

Meanwhile, if it is determined that the calculated difference is equal to or smaller than the radar determination threshold, the monitoring unit 14 determines that the reliability of the distance information acquired from the millimeter wave radar 22 has not decreased, and outputs monitoring result information indicating that the reliability of the distance information has not decreased to the control unit 15e.

The control unit 15e adds an information effectiveness flag to vehicle surrounds information on the basis of the determination result determined by the monitoring unit 14 in step ST1503 (step ST1504). Specifically, for example, when the monitoring unit 14 determines that the reliability of the distance information acquired from the millimeter wave radar 22 has decreased, the control unit 15e adds an information effectiveness flag “0” to the distance information. The control unit 15e may acquire the distance information from the monitoring unit 14. For example, when the monitoring unit 14 determines that the reliability of the distance information acquired from the millimeter wave radar 22 has not decreased, the control unit 15 adds an information effectiveness flag “1” to the distance information.

Similarly to the premise of the first embodiment, the sixth embodiment is on the premise that substantially no problem occurs in the captured image taken by the camera 21, and therefore the control unit 15e adds an information effectiveness flag “1” to the captured image all the time.

The control unit 15e outputs the flagged vehicle surrounds information to the control amount inferring unit 12e.

The control amount inferring unit 12e infers an automatic driving control amount of the vehicle 100 on the basis of the flagged vehicle surrounds information output from the control unit 15e and the machine learning model 13e (step ST1505). Then, the control amount inferring unit 12e outputs vehicle control information based on the inferred automatic driving control amount to the vehicle control unit 3 (step ST1506).

As described above, the automatic driving control device 1e can include only one control amount inferring unit 12e and only one machine learning model 13e. As a result, it is not necessary to prepare a plurality of machine learning models according to the number of pieces of vehicle surrounds information to be input, and thus an automatic driving control amount can be inferred with a simpler configuration as compared with a case where a plurality of machine learning models according to the number of pieces of vehicle surrounds information is prepared.

In addition, by adding an information effectiveness flag to vehicle surrounds information at the time of inference of an automatic driving control amount, the automatic driving control device 1e can determine whether or not the vehicle surrounds information is effective to be used for inference of the automatic driving control amount. As a result, the automatic driving control device 1e can infer an automatic control amount that is available for automatic driving control of the vehicle 100 even when the reliability of vehicle surrounds information output from one or more sensors among the plurality of sensors has decreased.

As described above, according to the sixth embodiment, the automatic driving control device 1e includes: the information acquisition unit 11 for acquiring a plurality of pieces of vehicle surrounds information output from a plurality of respective sensors (the camera 21 and the millimeter wave radar 22); the control amount inferring unit 12e for inferring an automatic driving control amount on the basis of the plurality of pieces of vehicle surrounds information acquired by the information acquisition unit 11 and the machine learning model 13, and outputting the automatic driving control amount; the monitoring unit 14 for determining whether or not the reliability of any one of the plurality of pieces of vehicle surrounds information acquired by the information acquisition unit 11 has decreased; and the control unit 15e for controlling, when the monitoring unit 14 determines that the reliability of any one of the plurality of pieces of vehicle surrounds information has decreased, the control amount inferring unit 12e in such a way as to output the automatic driving control amount excluding an influence of the one of the plurality of pieces of vehicle surrounds information whose reliability is determined to be decreased.

Therefore, the automatic driving control device 1e for inferring and outputting an automatic driving control amount, on the basis of the plurality of pieces of vehicle surrounds information output from the plurality of respective sensors and the machine learning model 13, can output an automatic driving control amount suitable for automatic driving control of the vehicle 100 even when the reliability of any one of the plurality of pieces of vehicle surrounds information has decreased.

More specifically, in the automatic driving control device 1e according to the sixth embodiment, the control unit 15e adds an information effectiveness flag based on a result of the reliability determination by the monitoring unit 14 to each of the plurality of pieces of vehicle surrounds information acquired by the information acquisition unit 11, and the control amount inferring unit 12e infers an automatic driving control amount on the basis of the machine learning model 13e and all of the plurality of pieces of vehicle surrounds information to each of which the information effectiveness flag is added by the control unit 15e, and outputs the automatic driving control amount. Therefore, the automatic driving control device 1e for inferring and outputting an automatic driving control amount, on the basis of the plurality of pieces of vehicle surrounds information output from the plurality of respective sensors and the machine learning model 13e, can output an automatic driving control amount suitable for automatic driving control of the vehicle 100 even when the reliability of any one of the plurality of pieces of vehicle surrounds information has decreased. In addition, an automatic driving control amount can be inferred with a simpler configuration as compared with a case where the machine learning model 13e is prepared depending on the type of vehicle surrounds information.

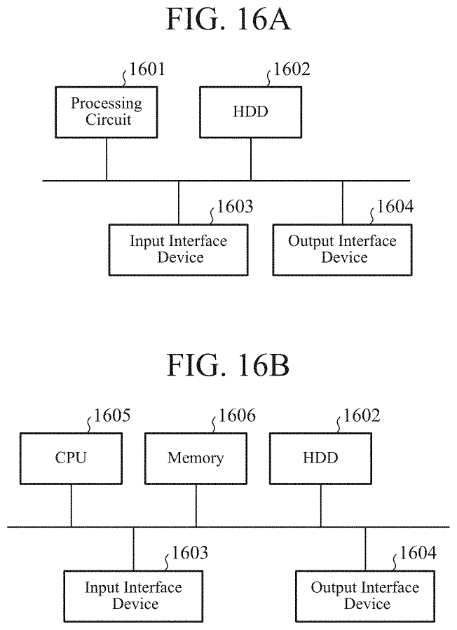

FIGS. 16A and 16B are diagrams illustrating examples of a hardware configuration of the automatic driving control devices 1 to 1e according to the first to sixth embodiments.

In the first to sixth embodiments, the functions of the information acquisition unit 11, the control amount inferring units 12 to 12e, the monitoring units 14 to 14c, the control units 15 and 15e, the weather determination unit 16, the travel determination unit 17, and the notification control unit 18 are implemented by a processing circuit 1601. That is, the automatic driving control devices 1 to 1e each include the processing circuit 1601 for inferring an automatic driving control amount for controlling automatic driving of the vehicle 100.

The processing circuit 1601 may be dedicated hardware as illustrated in FIG. 16A or a central processing unit (CPU) 1605 for executing a program stored in a memory 1606 as illustrated in FIG. 16B.

When the processing circuit 1601 is dedicated hardware, for example, a single circuit, a composite circuit, a programmed processor, a parallel programmed processor, an application specific integrated circuit (ASIC), a field-programmable gate array (FPGA), or a combination thereof corresponds to the processing circuit 1601.

When the processing circuit 1601 is the CPU 1605, the functions of the information acquisition unit 11, the control amount inferring units 12 to 12e, the monitoring units 14 to 14c, the control units 15 and 15e, the weather determination unit 16, the travel determination unit 17, and the notification control unit 18 are implemented by software, firmware, or a combination of software and firmware. That is, the information acquisition unit 11, the control amount inferring units 12 to 12e, the monitoring units 14 to 14c, the control units 15 and 15e, the weather determination unit 16, the travel determination unit 17, and the notification control unit 18 are implemented by a processing circuit such as the CPU 1605 or a system large-scale integration (LSI) for executing a program stored in a hard disk drive (HDD) 1602, the memory 1606, or the like. In addition, it can also be said that the program stored in the HDD 1602, the memory 1606, or the like causes a computer to execute procedures or methods performed by the information acquisition unit 11, the control amount inferring units 12 to 12e, the monitoring units 14 to 14c, the control units 15 and 15e, the weather determination unit 16, the travel determination unit 17, and the notification control unit 18. Here, for example, a nonvolatile or volatile semiconductor memory such as a RAM, a read only memory (ROM), a flash memory, an erasable programmable read only memory (EPROM), or an electrically erasable programmable read-only memory (EEPROM), a magnetic disk, a flexible disk, an optical disc, a compact disc, a mini disc, or a digital versatile disc (DVD) corresponds to the memory 1606.

Note that some of the functions of the information acquisition unit 11, the control amount inferring units 12 to 12e, the monitoring units 14 to 14c, the control units 15 and 15e, the weather determination unit 16, the travel determination unit 17, and the notification control unit 18 may be implemented by dedicated hardware, and some of the functions may be implemented by software or firmware. For example, the function of the information acquisition unit 11 can be implemented by the processing circuit 1601 as dedicated hardware, and the functions of the control amount inferring units 12 to 12e, the monitoring units 14 to 14c, the control units 15 and 15e, the weather determination unit 16, the travel determination unit 17, and the notification control unit 18 can be implemented when the processing circuit 1601 reads and executes a program stored in the memory 1606.

In addition, the automatic driving control devices 1 to 1e each include an input interface device 1603 and an output interface device 1604 for performing wired communication or wireless communication with a device such as a sensor, the vehicle control unit 3, or an output device.

Note that in the above-described first to sixth embodiments, the automatic driving control devices 1 to 1e are in-vehicle devices mounted on the vehicle 100, and the information acquisition unit 11, the control amount inferring units 12 to 12e, the monitoring units 14 to 14c, the control units 15 and 15e, the weather determination unit 16, the travel determination unit 17, and the notification control unit 18 are included in the automatic driving control devices 1 to 1e.

Not limited to this, some units among the information acquisition unit 11, the control amount inferring units 12 to 12e, the monitoring units 14 to 14c, the control units 15 and 15e, the weather determination unit 16, the travel determination unit 17, and the notification control unit 18 may be mounted on an in-vehicle device of the vehicle 100, and the other units may be included in a server connected to the in-vehicle device via a network. In this manner, the in-vehicle device and the server may constitute an automatic driving control system.

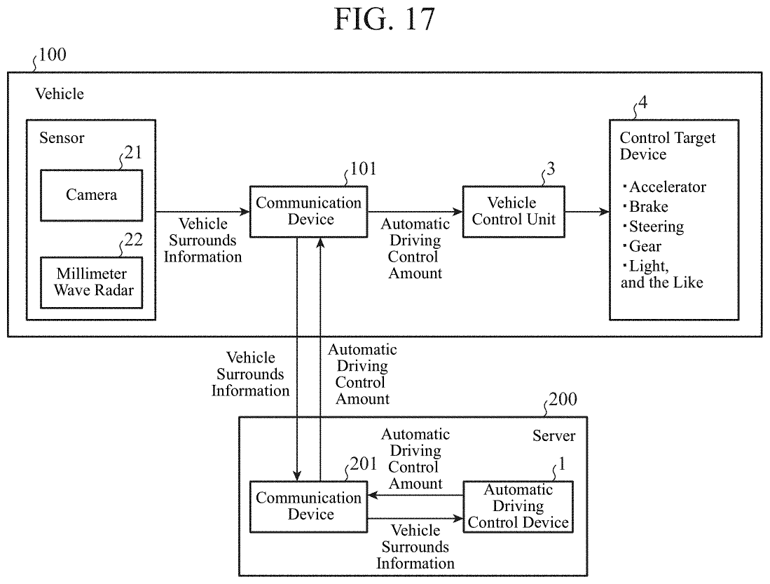

FIG. 17 is a diagram illustrating a configuration example of an automatic driving control system in which the automatic driving control device 1 according to the first embodiment described with reference to FIG. 2 is included in a server 200.

In the automatic driving control system as illustrated in FIG. 17 as an example, the automatic driving control device 1 and an in-vehicle device are connected to each other via a communication device 101 and a communication device 201. Vehicle surrounds information acquired by a sensor is transmitted to the automatic driving control device 1 on the server 200 via the communication device 101 and the communication device 201. The automatic driving control device 1 infers an automatic driving control amount on the basis of the vehicle surrounds information received from the in-vehicle device. Then, the automatic driving control amount inferred by the automatic driving control device 1 is transmitted to the vehicle control unit 3 mounted on the in-vehicle device via the communication device 201 and the communication device 101. The vehicle control unit 3 controls the control target device 4 on the basis of the acquired automatic driving control amount.

Note that here, as an example, all the functions of the automatic driving control device 1 are included in the server 200, but some of the functions of the automatic driving control device 1 may be included in the server 200. For example, the information acquisition unit 11 and the monitoring unit 14 of the automatic driving control device 1 can be included in the in-vehicle device, and the other functions of the automatic driving control device 1 can be included in the server 200.

In addition, in FIG. 17, as an example, in the automatic driving control system, the automatic driving control device 1 according to the first embodiment is included in the server 200. However, in the automatic driving control system, any one of the automatic driving control devices 1a to 1e according to the second to sixth embodiments may be included in the server 200. In the automatic driving control system, when any one of the automatic driving control devices 1a to 1e according to the second to sixth embodiments is included in the server 200, some or all of the functions of the one of the automatic driving control devices 1a to 1e are included in the server 200 in the configuration example as illustrated in FIG. 17.

In addition, the invention of the present application can freely combine the embodiments with one another, modify any component in each of the embodiments, or omit any component in each of the embodiments within the scope of the invention.

### INDUSTRIAL APPLICABILITY

The automatic driving control device according to the present invention can be applied to an automatic driving control device that performs automatic driving control of a vehicle.

### REFERENCE SIGNS LIST

1 to 1e: Automatic driving control device, 11: Information acquisition unit, 12 to 12c, 12e: Control amount inferring unit, 121: First control amount inferring unit, 122 to 122c: Second control amount inferring unit, 123: Selection unit, 13 to 13c, 13e: Machine learning model, 131: First machine learning model, 132 to 132c: Second machine learning model, 14 to 14c: Monitoring unit, 15, 15e: Control unit, 16: Weather determination unit, 17: Travel determination unit, 18: Notification control unit, 21: Camera, 22: Millimeter wave radar, 23: GNSS, 24: Vehicle travel sensor, 3: Vehicle control unit, 4: Control device, 200: Server, 101, 201: Communication device, 1601: Processing circuit, 1602: HDD, 1603: Input interface device, 1604: Output interface device, 1605: CPU, 1606: Memory

1. An automatic driving control device comprising:
processing circuitry
to acquire a plurality of pieces of vehicle surrounds information output from a plurality of respective sensors;
to infer an automatic driving control amount on a basis of the plurality of pieces of vehicle surrounds information acquired and at least one machine learning model, and output the automatic driving control amount;
to determine whether or not reliability of any one of the plurality of pieces of vehicle surrounds information acquired has decreased; and
to perform, when it is determined that the reliability of any one of the plurality of pieces of vehicle surrounds information has decreased, control in such a way as to output the automatic driving control amount excluding an influence of the one of the plurality of pieces of vehicle surrounds information whose reliability is determined to be decreased.

2. The automatic driving control device according to claim 1, wherein
the processing circuitry for infers a first automatic driving control amount on a basis of all of the plurality of pieces of vehicle surrounds information acquired and a first machine learning model; and infers a second automatic driving control amount on a basis of a part of the plurality of pieces of vehicle surrounds information acquired and a second machine learning model, and
the processing circuitry performs the control in such a way as to output the second automatic driving control amount when it is determined that reliability of a piece of vehicle surrounds information other than the part of the plurality of pieces of vehicle surrounds information input to the second machine learning model among the plurality of pieces of vehicle surrounds information has decreased.

3. The automatic driving control device according to claim 2, wherein
the processing circuitry selects, from the first automatic driving control amount and the second automatic driving control amount, which to output, and
the processing circuitry selects and outputs the second automatic driving control amount when the processing circuitry performs the control in such a way as to output the second automatic driving control amount.

4. The automatic driving control device according to claim 2, wherein
the processing circuitry infers the second automatic driving control amount when the processing circuitry performs the control in such a way as to output the second automatic driving control amount.

5. The automatic driving control device according to claim 1, wherein
the processing circuitry adds an information effectiveness flag based on a result of the reliability determination to each of the plurality of pieces of vehicle surrounds information acquired by the information acquisition unit, and
the processing circuitry infers the automatic driving control amount on a basis of the machine learning model and all of the plurality of pieces of vehicle surrounds information to each of which the information effectiveness flag is added, and outputs the automatic driving control amount.

6. The automatic driving control device according to claim 1, wherein
the plurality of sensors includes at least a camera and a millimeter wave radar,
the processing circuitry acquires, as the plurality of pieces of vehicle surrounds information, at least a captured image obtained by capturing an object present around a vehicle with the camera and distance information regarding a distance to the object measured by the millimeter wave radar, and
the processing circuitry determines that reliability of the distance information acquired from the millimeter wave radar has decreased when a difference between a distance to the object based on the captured image acquired and a distance to the object based on the distance information acquired is larger than a radar determination threshold.

7. The automatic driving control device according to claim 1, wherein
one of the plurality of sensors is a camera,
the processing circuitry acquires, as one of the plurality of pieces of vehicle surrounds information, a captured image obtained by capturing an area around a vehicle with the camera,
the processing circuitry determines weather around the vehicle, and
the processing circuitry determines whether or not reliability of the captured image acquired from the camera has decreased on a basis of the weather determined.

8. The automatic driving control device according to claim 7, wherein
the processing circuitry determines that the reliability of the captured image acquired from the camera has decreased when it is determined that there is fog or precipitation around the vehicle.

9. The automatic driving control device according to claim 1, wherein
one of the plurality of sensors is a camera,
the processing circuitry acquires, as one of the plurality of pieces of vehicle surrounds information, a captured image obtained by capturing an area around a vehicle with the camera, and
the processing circuitry determines whether or not reliability of the captured image acquired from the camera has decreased on a basis of luminance of the captured image acquired.

10. The automatic driving control device according to claim 1, wherein
one of the plurality of sensors is a camera,
the processing circuitry acquires, as one of the plurality of pieces of vehicle surrounds information, a captured image obtained by capturing an area around a vehicle with the camera,
the processing circuitry determines whether or not the vehicle is traveling is comprised, and
the processing circuitry determines that reliability of the captured image acquired from the camera has decreased when it is determined that the vehicle is traveling and there is no change in scenery around the vehicle captured in the captured image acquired.

11. The automatic driving control device according to claim 2, wherein
the processing circuitry outputs notification information indicating that reliability of a part of the plurality of pieces of vehicle surrounds information has decreased when the processing circuitry performs the control in such a way as to output the second automatic driving control amount.

12. The automatic driving control device according to claim 11, wherein
the notification information is
a message indicating that one of the sensors which outputs a piece of vehicle surrounds information whose reliability is determined to be decreased is unavailable.

13. The automatic driving control device according to claim 11, wherein
the notification information is
a message giving a notification of a function that is unavailable for automatic driving control due to presence of a piece of vehicle surrounds information whose reliability is determined to be decreased.

14. An automatic driving control method comprising:
acquiring a plurality of pieces of vehicle surrounds information output from a plurality of respective sensors;
inferring an automatic driving control amount on a basis of the plurality of pieces of vehicle surrounds information acquired and at least one machine learning model, and outputting the automatic driving control amount;
determining whether or not reliability of any one of the plurality of pieces of vehicle surrounds information acquired has decreased; and
performing, when it is determined that the reliability of any one of the plurality of pieces of vehicle surrounds information has decreased, control in such a way as to output the automatic driving control amount excluding an influence of the one of the plurality of pieces of vehicle surrounds information whose reliability is determined to be decreased.
